(19) United States
(12) Patent Application Publication
(10) Pub. No.: US 2026/0025853 A1
(43) Pub. Date: Jan. 22, 2026

(54) OPPORTUNISTIC SHARED ACCESS TO A RECONFIGURABLE INTELLIGENT SURFACE

(71) Applicant: Apple Inc., Cupertino, CA (US)

(72) Inventors: Ankit BHAMRI, Haar (DE); Oghenekome OTERI, San Diego, CA (US); Haitong SUN, Saratoga, CA (US); Benedikt SCHWEIZER, Munich (DE); Bertram R. GUNZELMANN, Koenigsbrunn (DE); Sharad SAMBHWANI, San Diego, CA (US); Danila ZAEV, Munich (DE); Dawei ZHANG, Saratoga, CA (US)

(21) Appl. No.: 19/173,778

(22) Filed: Apr. 8, 2025

Related U.S. Application Data
(60) Provisional application No. 63/674,241, filed on Jul. 22, 2024.
(60) Provisional application No. 63/674,239, filed on Jul. 22, 2024.

(51) Int. Cl. H04W 74/0816; H04B 7/04; H04L 5/00; H04W 12/06

(52) U.S. Cl. CPC H04W 74/0816; H04B 7/04013; H04L 5/0053; H04W 12/06

(57) ABSTRACT

The subject technology provides for opportunistic shared access to a reconfigurable intelligent surface. An apparatus may determine whether opportunistic shared access to a reconfigurable intelligent surface (RIS) device is available. The apparatus also may provide control information for transmission to a controller associated with the RIS device based on a determination that opportunistic shared access to the RIS device is available. By providing electronic devices with opportunistic and fair access to a reconfigurable intelligent surface, the performance and reliability of reconfigurable intelligent surface systems is increased.

### CROSS-REFERENCE TO RELATED APPLICATION(S)

This application claims the benefit of U.S. Provisional Application Ser. No. 63/674,239, entitled “OPPORTUNISTIC SHARED ACCESS TO A RECONFIGURABLE INTELLIGENT SURFACE,” and filed on Jul. 22, 2024, and U.S. Provisional Application Ser. No. 63/674,241, entitled “OPPORTUNISTIC SHARED ACCESS TO A RECONFIGURABLE INTELLIGENT SURFACE,” and filed on Jul. 22, 2024, the disclosures of which are expressly incorporated by reference herein in their entirety.

### TECHNICAL FIELD

The present description generally relates to wireless communication systems and, in particular to, opportunistic shared access to a reconfigurable intelligent surface.

### BACKGROUND

Electronic devices are often provided with wireless capabilities. An electronic device with wireless capabilities has wireless circuitry that includes one or more antennas. The wireless circuitry is used to perform communications using radio-frequency signals conveyed by the antennas. As software applications on electronic devices become more data-intensive over time, demand has grown for electronic devices that support wireless communications at higher data rates. However, the maximum data rate supported by electronic devices is limited by the frequency of the radio-frequency signals. As the frequency of the radio-frequency signals increases, it can become increasingly difficult to perform satisfactory wireless communications because the signals become subject to significant over-the-air attenuation and typically require line-of-sight.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2A is a schematic diagram illustrating an example configuration for network-controlled access to a reconfigurable intelligent surface in accordance with one or more implementations.

FIG. 2B is a schematic diagram illustrating an example configuration for autonomous access to a reconfigurable intelligent surface in accordance with one or more implementations.

FIG. 3A is a schematic diagram illustrating an example configuration for user equipment (UE)-controlled access to a reconfigurable intelligent surface in accordance with one or more implementations.

FIG. 3B is a schematic diagram illustrating an example configuration for UE-controlled access to a reconfigurable intelligent surface for serving multiple UEs in accordance with one or more implementations.

FIG. 4 conceptually illustrates an example of a system for performing signaling between a user equipment (UE) and a network entity in an access network in accordance with one or more implementations.

FIG. 5A is a schematic diagram illustrating an example configuration for uncoordinated opportunistic access to a reconfigurable intelligent surface in accordance with one or more implementations.

FIG. 5B is a schematic diagram illustrating an example configuration for coordinated opportunistic access to a reconfigurable intelligent surface in accordance with one or more implementations.

FIG. 6 is a schematic diagram illustrating an example communication between multiple UEs and a network entity for uncoordinated opportunistic access to a reconfigurable intelligent surface in accordance with one or more implementations.

FIG. 7 is a schematic diagram illustrating another example communication between multiple UEs and a network entity for uncoordinated opportunistic access to a reconfigurable intelligent surface in accordance with one or more implementations.

FIG. 8 is a schematic diagram illustrating yet another example communication between multiple UEs and a network entity for uncoordinated opportunistic access to a reconfigurable intelligent surface in accordance with one or more implementations.

FIG. 9 is a schematic diagram illustrating an example communication between multiple UEs and a network entity for coordinated opportunistic access to a reconfigurable intelligent surface in accordance with one or more implementations.

FIG. 10 is a schematic diagram illustrating another example communication between multiple UEs and a network entity for coordinated opportunistic access to a reconfigurable intelligent surface in accordance with one or more implementations.

FIG. 11 is a flow chart of an example process that may be performed by baseband processing circuitry of a UE for opportunistic shared access to a reconfigurable intelligent surface in accordance with one or more implementations.

FIG. 12 is a flow chart of an example process that may be performed by baseband processing circuitry of a network entity for opportunistic shared access to a reconfigurable intelligent surface in accordance with one or more implementations.

FIG. 13 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

The ubiquity of wireless communication systems underscores their role in delivering a plethora of telecommunication services spanning telephony, video streaming, data transmission, messaging, and broadcasting. These systems, typically leveraging multiple-access technologies, facilitate communication with numerous users by efficiently allocating system resources. These technologies encompass a range of methodologies such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and Time Division Synchronous Code Division Multiple Access (TD-SCDMA).

This versatility in multiple-access technologies has been instrumental in their adoption across various telecommunication standards, establishing a unified protocol that facilitates seamless communication among diverse wireless devices across different geographic scales—from local municipalities to national, regional, and global networks. An example of such standards is the Fifth Generation (5G) New Radio (NR), an integral component of the ongoing mobile broadband evolution spearheaded by the Third Generation Partnership Project (3GPP). 5G NR is designed to meet evolving requirements concerning latency, reliability, security, scalability (including integration with the Internet of Things (IoT)), and other critical parameters. It encompasses services catering to Enhanced Mobile Broadband (cMBB), Massive Machine Type Communications (mMTC), and Ultra-Reliable Low Latency Communications (URLLC).

While communications at high frequencies allow for significant high data rates (e.g., greater than 100 Gbps), wireless signals at such high frequencies are subject to significant attenuation during propagation over-the-air. Integrating antennas of user equipment (UEs) into phased antenna arrays may help to counteract this attenuation by boosting the gain of the signals within a signal beam. However, signal beams are highly directive and may require a line-of-sight (LOS) between a UE and a network entity. If an obstruction is present between a UE and a network entity, the obstruction may block the LOS between the UE and the base station, which can disrupt wireless communications using communication links. In one or more implementations, a reconfigurable intelligent surface (RIS) device may be used to allow the UE and the base station to continue to communicate using communication links even when an obstruction blocks the LOS between the UE and the base station.

In one or more implementations, a UE-controlled RIS configuration to access a RIS device may be interoperable across UEs subscribed to different network operators, facilitating seamless operation in diverse environments. These systems are also potentially portable and can be deployed or relocated, catering to personal device needs. In one or more implementations, UE-controlled RIS configurations include residential areas such as houses, condos, and apartment complexes, as well as public indoor spaces such as conference rooms, community areas, and classrooms, and commercial environments such as shopping malls.

An example framework for a UE-controlled RIS configuration serving multiple UEs may involve a primary controlling UE (e.g., UE1) managing the configuration of RIS elements (e.g., antenna elements). In the UE-controlled RIS configuration, UE1 acts as the controlling node responsible for transmitting control information to a RIS controller. When another UE (e.g., UE2) needs to access the RIS device, UE2 can send its control information to UE1. UE1 then forwards this control information to the RIS controller, which applies the requested configurations to serve UE2.

In one or more implementations, the UE-controlled RIS configuration for serving multiple UEs faces several challenges. In one or more implementations, there may be an increase in hop and overhead for control information exchange, where data from UEs needs to pass through the primary controlling UE before reaching the RIS controller. This additional hop adds complexity and can affect overall system efficiency. In one or more other implementations, there may be added latency in the UE-controlled RIS configuration due to the additional hop. The primary controlling UE may need to decode, process, and authenticate information from other UEs before forwarding it to the RIS controller, which can lead to delays in responsiveness. In one or more other implementations, there may be privacy and security concerns. The primary controlling UE potentially gains access to sensitive information such as scheduling and localization data from other UEs. This access may raise potential privacy risks and security vulnerabilities, as UEs may be apprehensive about their data being accessed or intercepted by unauthorized parties during transmission.

Embodiments of the subject technology provide for an enhanced framework for UE-controlled RIS configurations aimed at mitigating the aforementioned challenges, such as reducing the additional hop needed for transmitting control information to the RIS controller, minimizing latency in the UE-controlled RIS configuration, and preventing the sharing of sensitive information among UEs. Specifically, the enhanced framework provides for enabling access to the RIS controller through multiple nodes, addressing both opportunistic and fair access scenarios. The subject technology aims to enhance the performance and reliability of RIS systems while ensuring robust protection of user data and efficient resource utilization.

In one or more implementations, the term “opportunistic access” may be defined as the utilization of a RIS device to enhance wireless communication performance based on real-time network conditions and availability. This opportunistic access may include dynamic change of the controlling node that can dynamically adjust the UE-controlled RIS configuration to optimize signal propagation, reduce interference, and/or improve overall network efficiency. The controlling node can be a user device or a network node. The RIS device may operate by altering the phase, amplitude, or polarization of incident electromagnetic waves, enabling the redirection or reflection of wireless signals to achieve a desired coverage and quality of service. The access to the RIS device can be considered opportunistic as it may depend on the current network environment, user demand, and resource availability, allowing for adaptive and efficient use of the RIS device capabilities in varying scenarios.

In one or more implementations, the enhanced framework for the UE-controlled RIS configuration for serving multiple UEs includes a shared or opportunistic access approach to the RIS controller. For example, the UE-controlled RIS configuration allows multiple UEs to directly access the RIS controller and transmit control information for RIS device elements to serve themselves or other UEs. In one or more implementations, the UE-controlled RIS configuration may enable a UE to directly control the RIS device without needing to relay information through another UE (e.g., a primary controlling UE responsible for transmitting control signals to the RIS device on behalf of multiple UEs). This direct access can be advantageous for scenarios requiring dynamic scheduling of UEs or frequent beam updates, especially in higher frequency bands such as FR2 and beyond, where rapid beam updates facilitate efficient communication links.

In one or more implementations, the UE-controlled RIS configuration includes two frameworks for shared access to the RIS controller. In one or more implementations, a first framework may be an uncoordinated opportunistic access, where no coordination between UEs is needed to share access to the RIS controller. In one or more implementations, a second framework may be a coordinated shared access, which involves at least some level of coordination between UEs to share access to the RIS controller.

Embodiments of the subject technology provide for opportunistic shared access to a reconfigurable intelligent surface. An apparatus may determine whether opportunistic shared access to a RIS device is available. The apparatus also may provide control information for transmission to a controller associated with the RIS device based on a determination that opportunistic shared access to the RIS device is available. By providing electronic devices with opportunistic and fair access to a reconfigurable intelligent surface, the performance and reliability of reconfigurable intelligent surface systems is increased.

In one or more other implementations, an apparatus may receive, from at least one UE of a plurality of UEs, control information to access a RIS device. The apparatus also may determine whether opportunistic shared access to the RIS device is available using one or more resources indicated in the control information. The apparatus also may provide an indication for transmission to the at least one UE based on a determination that opportunistic shared access to the RIS device is available, the indication indicating that access to the RIS device is available to the UE.

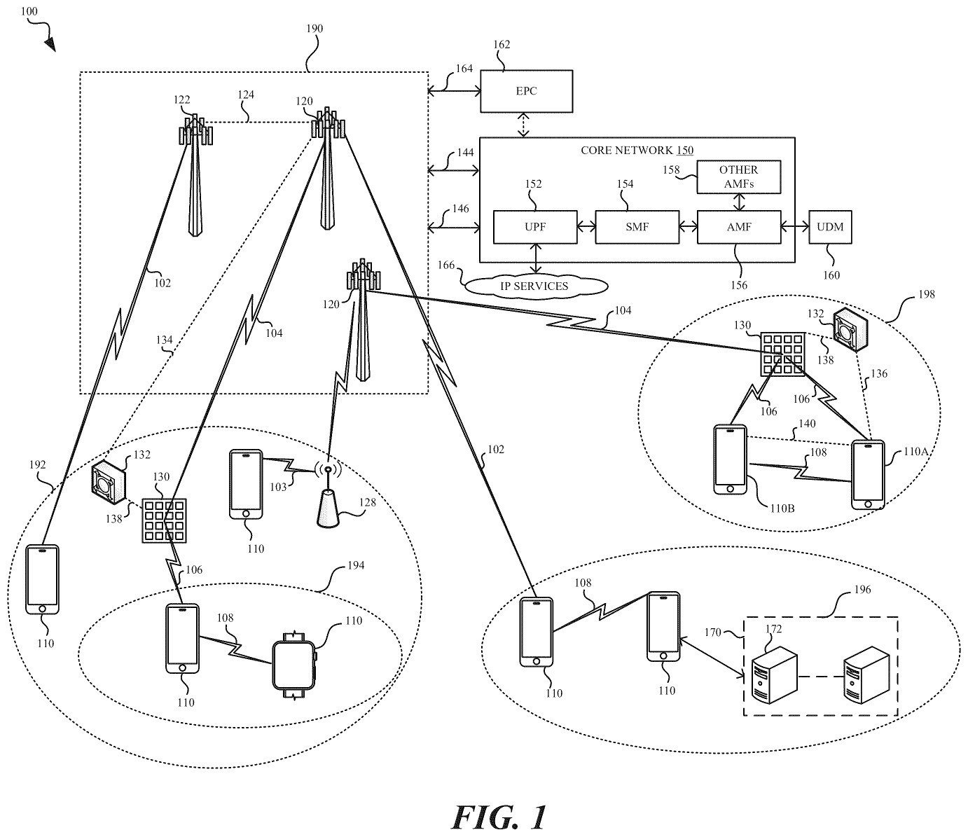

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The following description is provided for the network environment 100 that operates in conjunction with the Long-Term Evolution (LTE) system standards and/or 5G NR system standards as provided by 3GPP technical specifications and other 3GPP documents. The network environment 100 includes a radio access network (RAN) 190 and user equipment(s) (UE) 110. The RAN 190 includes base stations 120 and 122. The base stations may include macrocells and/or small cells (e.g., femtocells, picocells, microcells). The network environment 100 may further include a Wi-Fi access point (AP) 128 in communication with Wi-Fi stations (STAs) via communication links 103, e.g., in a 5 gigahertz (GHz) unlicensed frequency spectrum or the like.

The network environment 100 includes a core network 150 (e.g., a 5G Core) and an Evolved Packet Core (EPC) 162. The core network 150 may include an Access and Mobility Management Function (AMF) 156, other AMFs 158, a Session Management Function (SMF) 154, and a User Plane Function (UPF) 152. The AMF 156 may be in communication with a Unified Data Management (UDM) 160. The AMF 156 is the control node that processes the signaling between the UEs 110 and the core network 150. User IP packets can be transferred through the UPF 152. The UPF 152 provides UE IP address allocation as well as other functions. The UPF 152 is connected to the IP Services 166. The IP Services 166 may include the Internet, an intranet, an IMS, a Packet Switch (PS) Streaming Service, and/or other IP services.

The base stations 120 and 122 configured for 5G NR may interface with the core network 150 through backhaul links (e.g., NG interface). In one or more implementations, the RAN 190 may be connected with the core network 150 via an NG interface (e.g., backhaul links 144, 146). In one or more implementations, one or more of the backhaul links 144, 146 may be split into two parts, an NG user plane (NG-U) interface, which carries traffic data between the base station 120 or base station 122 and a user plane function (UPF) 152, and the S1 control plane (NG-C) interface, which is a signaling interface between the base station 120 or base station 122 and access and mobility management functions (AMFs) 156.

The base stations 120 and 122 configured for LTE may interface with the EPC 162 through backhaul links (e.g., S1 interface). In one or more implementations, the RAN 190 may be connected with the EPC 162 via an S1 interface (e.g., backhaul link 164). In one or more implementations, the backhaul link 164 may be split into two parts, an S1 user plane (S1-U) interface, which carries traffic data between the base station 120 and base station 122 and a serving gateway (S-GW), and the S1-MME interface, which is a signaling interface between the base station 120 or base station 122 and mobility management entities (MMEs).

The base stations 120 and 122 may communicate directly or indirectly (e.g., through the core network 150 or the EPC 162) with each other through backhaul links (e.g., Xn interface, X2 interface). The backhaul links may be wired or wireless. In one or more implementations, the base station 120 or the base station 122 may be configured to communicate with one another via interface 124.

The network entities (e.g., base stations 120 and 122) may wirelessly communicate with the UEs 110. Each of the network entities may provide communication coverage for a respective geographic coverage area (e.g., coverage areas 192, 194, 196, 198). There may be overlapping geographic coverage areas (e.g., coverage areas 192, 194). The communication links 102 between the network entities and the UEs 110 may include uplink transmissions from a UE 110 to a network entity and/or downlink transmissions from a network entity to a UE 110. The communication links 102 may use multiple-input and multiple-output antenna technology, including spatial multiplexing, beamforming, and/or transmit diversity. The communication links may be through one or more component carriers. The component carriers may include a primary component carrier (e.g., primary cell (PCell)) and one or more secondary component carriers (e.g., secondary cell (SCell)).

In one or more implementations, the electromagnetic spectrum is subdivided, based on frequency/wavelength, into various classes, bands, channels, or the like. In 5G NR, a first operating band referred to as frequency range 1 or FR1 can include frequencies in the range of 410 MHz to 13.125 GHZ, and a second operating band referred to as frequency range 2 or FR2 can include frequencies in the range of 24.25 GHz to 52.6 GHZ.

In one or more implementations, UEs 110 may communicate with each other using sidelink communication link 108. The sidelink communication link 108 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and a physical sidelink feedback channel (PSFCH).

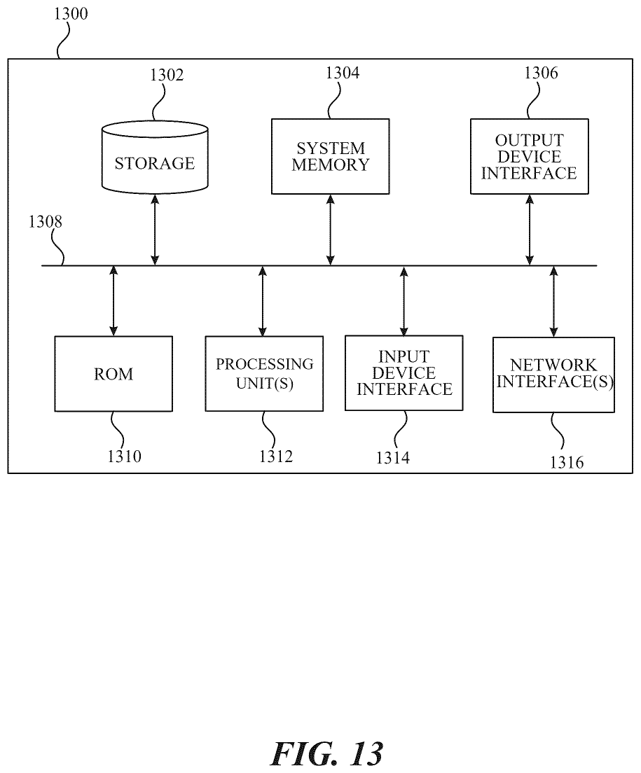

For explanatory purposes, the network environment 100 is illustrated in FIG. 1 as including the UEs 110 and a group of servers 170 in the coverage area 196; however, the network environment 100 may include any number of UEs and any number of servers or a data center including multiple servers in one or more coverage areas of the network environment 100. The UEs 110 may be, and/or may include all or part of, the electronic system discussed below with respect to FIG. 13.

The server 172 may form all or part of a network of computers or the group of servers 170, such as in a cloud computing or data center implementation. For example, the server 172 stores data and software, and includes specific hardware (e.g., processors, graphics processors and other specialized or custom processors) for rendering and generating content such as graphics, images, video, audio and multi-media files. In an implementation, the server 172 may function as a cloud storage server that stores any of the aforementioned content generated by the above-discussed devices and/or the server 172.

The server 172 may provide a system for training a machine learning model using training data, where the trained machine learning model is subsequently deployed to the server 172 and/or to one or more of the UEs 110. In an implementation, the server 172 may train a given machine learning model for deployment to a client electronic device (e.g., the UE 110). In one or more implementations, the server 172 may train portions of the machine learning model that are trained using (e.g., anonymized) training data from a population of users, and one or more of the UEs 110 may train portions of the machine learning model that are trained using individual training data from the user of the UEs 110. The machine learning model deployed on the server 172 and/or one or more of the UEs 110 can then perform one or more machine learning algorithms. In an implementation, the server 172 provides a cloud service that utilizes the trained machine learning model and/or continually learns over time.

In one or more implementations, one or more of the UEs 110 may provide a system for training a machine learning model using training data, where the trained machine learning model is subsequently deployed to one or more of the UEs 110. Further, one or more of the UEs 110 may provide one or more machine learning frameworks for training machine learning models and/or developing applications using such machine learning models. In an example, such machine learning frameworks can provide various machine learning algorithms and models for different problem domains in machine learning. In an example, the UE 110 may include a deployed machine learning model that provides an output of data corresponding to a prediction or some other type of machine learning output. In one or more implementations, training and inference operations that involve individually identifiable information of a user of one or more of the UEs 110 may be performed entirely on the UEs 110, to prevent exposure of individually identifiable data to devices and/or systems that are not authorized by the user.

One or more of the network entities may include and/or be referred to as a gNB, Node B, eNB, an access point, a base transceiver station, a radio base station, a radio transceiver, a transceiver function, a basic service set (BSS), an extended service set (ESS), a transmit reception point (TRP), a satellite base station, a base station, a reconfigurable intelligent surface (RIS), or some other suitable terminology without departing from the scope of the present disclosure. Each of the network entities (e.g., base stations 120 and 122) can provide an access point to the EPC 162 or core network 150 for a UE 110.

Examples of UEs 110 include a cellular phone, a smart phone, a session initiation protocol phone, a laptop, a satellite radio, a global positioning system, a multimedia device, a video device, a digital audio player, a personal digital assistant, a camera, a game console, a tablet, a smart device, a wearable device, a smart watch, a vehicle, an electric meter, a gas pump, a kitchen appliance, a healthcare device, an implant, a sensor, an actuator, a display, or any other similar functioning device. Some of the UEs 110 may be referred to as Internet-of-Things (IoT) devices. The UE 110 may also be referred to as an electronic device, a station, a mobile station, a subscriber unit, a subscriber station, a mobile subscriber station, a mobile unit, a wireless unit, a remote unit, a mobile device, a wireless device, a wireless communications device, a remote device, an access terminal, a mobile terminal, a wireless terminal, a remote terminal, a handset, a user agent, a mobile client, a client, or some other suitable terminology without departing from the scope of the present disclosure.

While communications at high frequencies allow for extremely high data rates (e.g., greater than 100 Gbps), wireless signals at such high frequencies are subject to significant attenuation during propagation over-the-air. Integrating antennas of the UEs 110 into phased antenna arrays may help to counteract this attenuation by boosting the gain of the signals within a signal beam. However, signal beams are highly directive and may require a line-of-sight (LOS) between a UE (e.g., UE 110) and a network entity (e.g., base station 120, 122). If an obstruction is present between a UE (e.g., UE 110) and a network entity (e.g., base station 120, 122), the obstruction may block the LOS between the UE 110 and the base station 120, which can disrupt wireless communications using communication links 102. In one or more implementations, a reconfigurable intelligent surface (RIS) device may be used to allow the UE 110 and the base station 120 to continue to communicate using communication links even when an obstruction blocks the LOS between the UE 110 and the base station 120 (or whenever direct over-the-air communications between the UE 110 and the base station 120 otherwise exhibits less than optimal performance).

As illustrated in FIG. 1, the network environment 100 may include one or more reconfigurable intelligent surfaces such as RIS device 130. In one or more implementations, the RIS device 130 may be referred to as an intelligent reconfigurable surface, an intelligent reflective/reflecting surface, a reflective intelligent surface, a reflective surface, a reflective device, a reconfigurable reflective device, a reconfigurable reflective surface, or a reconfigurable surface. In one or more implementations, a UE (e.g., UE 110) may be separated from a network entity (e.g., base station 120) by a line-of-sight (LOS) path. In one or more implementations, an obstruction (not shown) may block the LOS path. The obstruction may be, for example, part of a building such as a wall, window, floor, or ceiling (e.g., when UE 110 is located indoors), furniture, a body or body part, an animal, a cubicle wall, a vehicle, a landscape feature, or other obstacles or objects that may block the LOS path between the UE 110 and base station 120 (or base station 122).

In one or more implementations, in the absence of an obstruction, the base station 120 may form a corresponding Downlink beam of wireless signals oriented in the direction of the coverage area 198 including the UE 110 and the UE 110 may form a corresponding Uplink beam of wireless signals oriented in the direction of the base station 120. The UE 110 and the base station 120 can then convey wireless signals over their respective signal beams and the LOS path. However, the presence of the obstruction may prevent the wireless signals between the UE 110 and the base station 120 from being conveyed over the LOS path.

In one or more implementations, the RIS device 130 may be placed or disposed within the network environment 100 in such a way to allow the RIS device 130 to reflect wireless signals between the UE 110 and base station 120 despite the presence of an obstruction within the LOS path. In one or more other implementations, the RIS device 130 may be used to reflect wireless signals between the UE 110 and base station 120 when reflection via the RIS device 130 offers superior radio-frequency propagation conditions relative to the LOS path regardless of the presence of an obstruction (e.g., when the LOS path between the UE 110 and RIS device 130 and the LOS path between the RIS device 130 and the base station 120 exhibit superior propagation/channel conditions than the direct LOS path between the UE 110 and base station 120).

When the RIS device 130 is placed within the network environment 100, the base station 120 may transmit wireless signals 104 towards the RIS device 130 (e.g., within a downlink beam oriented towards the RIS device 130 located in coverage area 192 rather than towards a UE) and the RIS device 130 may reflect wireless signals 106 towards a UE (e.g., within a reflected beam towards the UE 110 located in the coverage area 192). Conversely, the UE 110 may transmit wireless signals 106 towards the RIS device 130 (e.g., within an uplink beam oriented towards the RIS device 130 rather than towards a base station) and the RIS device 130 may reflect wireless signals 104 towards a base station (e.g., within a reflected beam towards the base station 120). In one or more implementations, the base station 120 may control the RIS device 130 through a control link 134. For example, the base station 120 may send control information through the control link 134 to a RIS controller 132 associated with the RIS device 130 to provide one or more configurations for RIS elements of the RIS device 130.

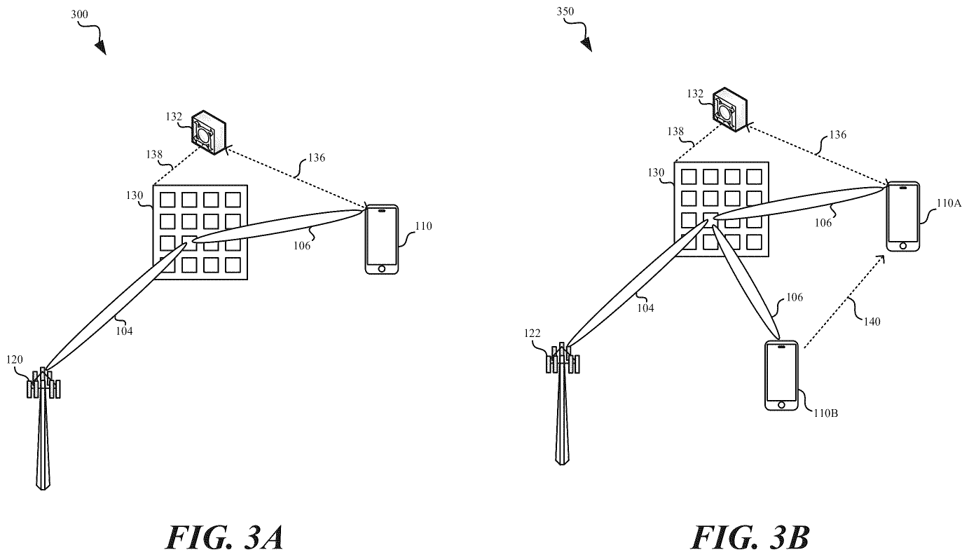

In one or more implementations, the RIS device 130 may be placed within the network environment 100 to serve multiple UEs. For example, the base station 120 may transmit wireless signals 104 towards the RIS device 130 (e.g., within a downlink beam oriented towards the RIS device 130 located in coverage area 198 rather than towards a UE) and the RIS device 130 may reflect wireless signals 106 towards a UE (e.g., within a reflected beam towards a UE 110a configured as a primary UE located in the coverage area 192). Conversely, the UE 110a serving as the primary UE in the coverage area 198 may transmit wireless signals 106 towards the RIS device 130 (e.g., within an uplink beam oriented towards the RIS device 130 rather than towards a base station) and the RIS device 130 may reflect wireless signals 104 towards a base station (e.g., within a reflected beam towards the base station 120). In one or more other implementations, the RIS device 130 may also reflect wireless signals 106 towards an additional UE (e.g., within a reflected beam towards a UE 110b configured as a secondary UE located in the coverage area 192). In one or more implementations, the RIS controller 132 may configure the RIS device 130 through a control link 138. In one or more implementations, the UE 110a as the primary UE may control the RIS device 130 through a control link 136. For example, the UE 110a may send control information through the control link 136 to the RIS controller 132 associated with the RIS device 130 to provide one or more configurations for RIS elements of the RIS device 130. In one or more other implementations, the UE 110a serving as the primary UE may communicate with the UE 110b serving as the secondary UE though a control link 140 to configure the RIS device 130 with one or more configurations associated with the UE 110b, as described in more detail with reference to FIG. 3B.

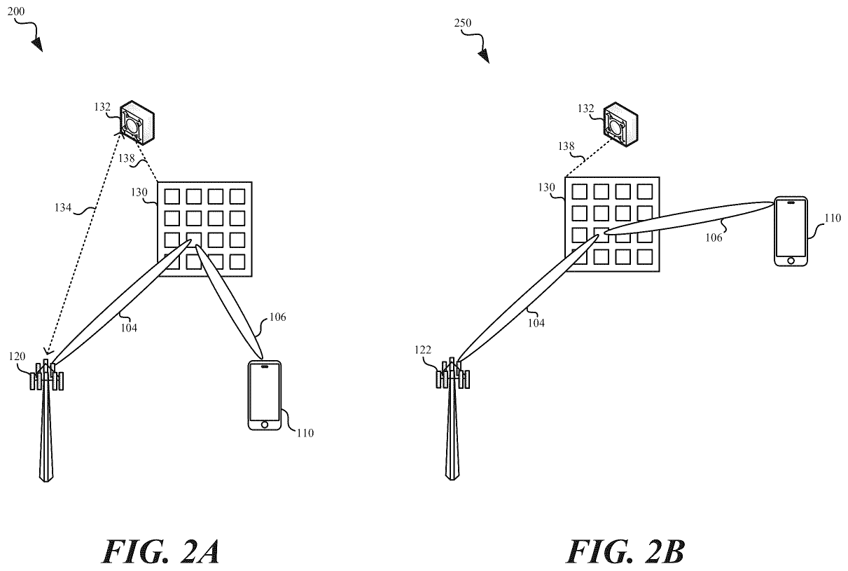

FIGS. 2A, 2B, 3A and 3B illustrate schematic diagrams of example configurations for controlling the RIS device 130. The operating modes (states) may be referred to herein as RIS control modes or states. FIG. 2A is a schematic diagram illustrating an example configuration for network-controlled access to a reconfigurable intelligent surface in accordance with one or more implementations. As shown in FIG. 2A, the RIS device 130 may be operated in a first control mode (state) such as a network-controlled RIS configuration 200. FIG. 2B is a schematic diagram illustrating an example configuration for autonomous access to a reconfigurable intelligent surface in accordance with one or more implementations. As shown in FIG. 2B, the RIS device 130 may be operated in a second control mode such as an autonomous RIS configuration 250. FIG. 3A is a schematic diagram illustrating an example configuration for UE-controlled access to a reconfigurable intelligent surface in accordance with one or more implementations. As shown in FIG. 3A, the RIS device 130 may be operated in a third control mode such as a UE-controlled RIS configuration 300. FIG. 3B is a schematic diagram illustrating an example configuration for UE-controlled access to a reconfigurable intelligent surface for serving multiple UEs in accordance with one or more implementations. As shown in FIG. 3B, the RIS device 130 may be operated in a UE-controlled RIS configuration 350 for serving multiple UEs.

In the network-controlled RIS configuration 200 as illustrated in FIG. 2A, the base station 120 may generate and/or select settings for antenna elements on the RIS device 130. The base station 120 may transmit control signals (e.g., via a control RAT, such as the control link 134, to the RIS controller 132) that control the RIS device 130 to configure (or program) the antenna elements of the RIS device 130 using the generated settings. The base station 120 may collect information from the RIS controller 132 and/or the UE 110 (e.g., via a control RAT and/or a data RAT) and may generate the settings for antenna elements of the RIS device 130 based on the collected information (e.g., the settings may configure antenna elements of the RIS device 130 to direct its signal beams in the direction of a location of the base station 120 and a location of UE 110). The base station 120 may continue to control the RIS device 130 via the RIS controller 132 to update its settings over time (e.g., as additional UE devices attempt to communicate with the base station 120, as the UE device moves or leaves a coverage area, etc.). The RIS controller 132 in this control mode may be deployed within the network environment 100 by the network operator associated with the base station 120.

In the autonomous RIS configuration 250 as illustrated in FIG. 2B, the RIS controller 132 may autonomously generate and/or autonomously select settings for antenna elements of the RIS device 130. The RIS controller 132 may collect information from the UE 110 and/or the base station 120 (e.g., via a control RAT and/or a data RAT when the RIS device 130 is an active RIS) and may generate the settings for antenna elements of the RIS device 130 based on the collected information (e.g., such that the settings configure antenna elements of the RIS device 130 to direct its signal beams in the direction of the location of the base station 120 and the location of UE 110). The RIS controller 132 may continue to autonomously control the RIS device 130 to update its settings over time (e.g., as the UE 110 moves or leaves a coverage area, as more UE devices join a coverage area, etc.). The RIS controller 132 in this control mode may be deployed within the network environment 100 by the network operator, may be pre-configured by the network operator, or may be separately deployed as an authorized or unauthorized third-party component, for example.

In the UE-controlled RIS configuration 300 as illustrated in FIG. 3A, the UE 110 may generate and/or select the settings for antenna elements on the RIS device 130. The UE 110 may transmit control signals (e.g., via a control RAT, such as the control link 136, to the RIS controller 132) that control the RIS device 130 to configure (or program) antenna elements of the RIS device 130 using the generated settings. The UE 110 may collect information from the RIS controller 132 and/or the base station 120 (e.g., via a control RAT and/or a data RAT) and may generate the settings for antenna elements of the RIS device 130 based on the collected information (e.g., such that the settings configure antenna elements of the RIS device 130 to direct its signal beams in the direction of the location of the base station 120 and the location of the UE 110). The UE 110 may continue to control the RIS device 130 via the RIS controller 132 to update its settings over time (e.g., as the UE device moves or leaves a coverage area, etc.). The RIS controller 132 in this control mode may be deployed within the network environment 100 by the network operator, may be pre-configured by the network operator, or may be separately deployed as an authorized or unauthorized third-party component, for example. In one or more implementations, the base station 120 may, for example, authorize the UE 110 to configure the RIS device 130 for a specific operating frequency range including licensed and/or an unlicensed spectrum. In one or more implementations, the UE 110 may pre-configure the RIS device 130 or may re-configure the RIS device 130 via the RIS controller 132.

In one or more implementations, the UE 110, the RIS controller 132, and/or the base station 120 may select which of the RIS control modes may be used by the RIS device 130 at any given time (e.g., based on signals conveyed over the data RAT and/or control RAT). The RIS control mode may be static (e.g., the RIS device 130 may use the same control mode for the duration of its installation, lifetime, or communication session) and/or may be dynamically adjusted between the RIS control modes over time (e.g., based on real-time needs of the network environment 100 and/or which of the RIS control modes would optimize the performance of the network environment 100 at any given time).

In the UE-controlled RIS configuration 350, as illustrated in FIG. 3B, a primary controlling UE (e.g., UE 110a) manages the configuration of RIS elements (e.g., antenna elements). In the UE-controlled RIS configuration, UE 110a acts as the controlling node responsible for transmitting control information to the RIS controller 132. When another UE (e.g., UE 110b) needs to access the RIS device 130, the UE 110b can send its control information to UE 110a via the control link 140. The UE 110a then forwards this control information to the RIS controller 132, which applies the requested configurations to serve UE 110b.

In one or more implementations, the UE-controlled RIS configuration 350 for serving multiple UEs faces several challenges. In one or more implementations, there may be an increase in hop and overhead for control information exchange, where data from the UE 110b needs to pass through the UE 110a serving as the primary controlling UE before reaching the RIS controller 132. This additional hop adds complexity and can affect overall system efficiency. In one or more other implementations, there may be added latency in the UE-controlled RIS configuration 350 due to the additional hop. The UE 110a as the primary controlling UE may need to decode, process, and authenticate information from the UE 110b before forwarding it to the RIS controller 132, which can lead to delays in responsiveness. In one or more other implementations, there may be privacy and security concerns. The UE 110a potentially gains access to sensitive information such as scheduling and localization data from the UE 110b. For example, the UE 110b may send measurements or optimal beam settings to the UE 110a. This access may raise potential privacy risks and security vulnerabilities, as UEs may be apprehensive about their data being accessed or intercepted by unauthorized parties during transmission.

Embodiments of the subject technology provide for an enhanced framework for UE-controlled RIS configurations aimed at mitigating the aforementioned challenges, such as reducing the additional hop needed for transmitting control information to the RIS controller 132, minimizing latency in the UE-controlled RIS configuration 350, and preventing the sharing of sensitive information among UEs. Specifically, the enhanced framework provides for enabling access to the RIS controller 132 through multiple nodes, addressing both opportunistic and fair access scenarios. The subject technology aims to enhance the performance and reliability of RIS systems while ensuring robust protection of user data and efficient resource utilization.

In one or more implementations, the enhanced framework for the UE-controlled RIS configuration 350 for serving multiple UEs includes a shared or opportunistic access approach to the RIS controller 132. For example, the UE-controlled RIS configuration 350 allows multiple UEs to directly access the RIS controller 132 and transmit control information for RIS elements to serve themselves or other UEs. In one or more implementations, the UE-controlled RIS configuration 350 may enable a UE (e.g., the UE 110a) to directly control the RIS device 130 without needing to relay information through the UE 110a (e.g., a primary controlling UE responsible for transmitting control signals to the RIS on behalf of multiple UEs). This direct access can be advantageous for scenarios requiring dynamic scheduling of UEs or frequent beam updates, especially in higher frequency bands such as FR2 and beyond, where rapid beam updates facilitate efficient communication links.

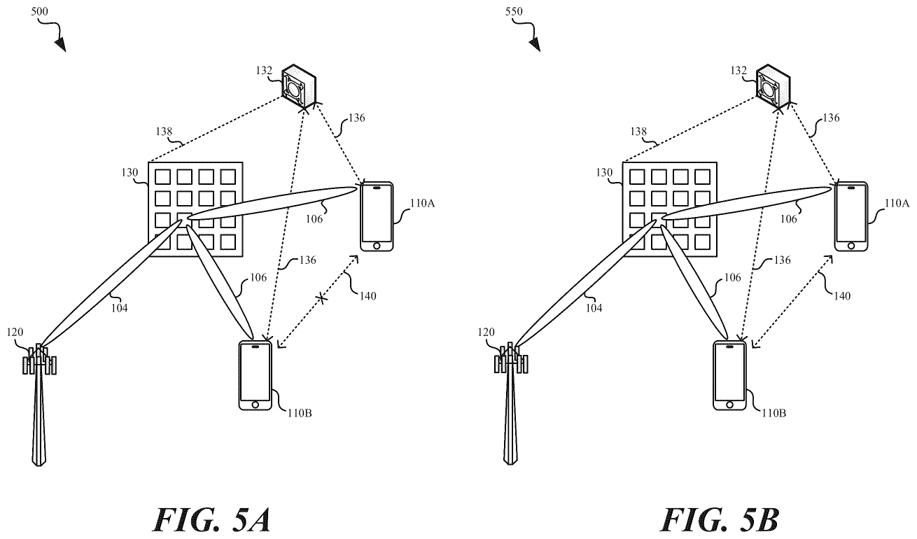

In one or more implementations, the UE-controlled RIS configuration 350 may include two frameworks for shared access to the RIS controller. In one or more implementations, a first framework may be an uncoordinated opportunistic access, where no coordination between UEs is needed to share access to the RIS controller 132, as described with reference to FIG. 5A. In one or more implementations, a second framework may be a coordinated shared access, which involves at least some level of coordination between UEs to share access to the RIS controller 132, as described with reference to FIG. 5B.

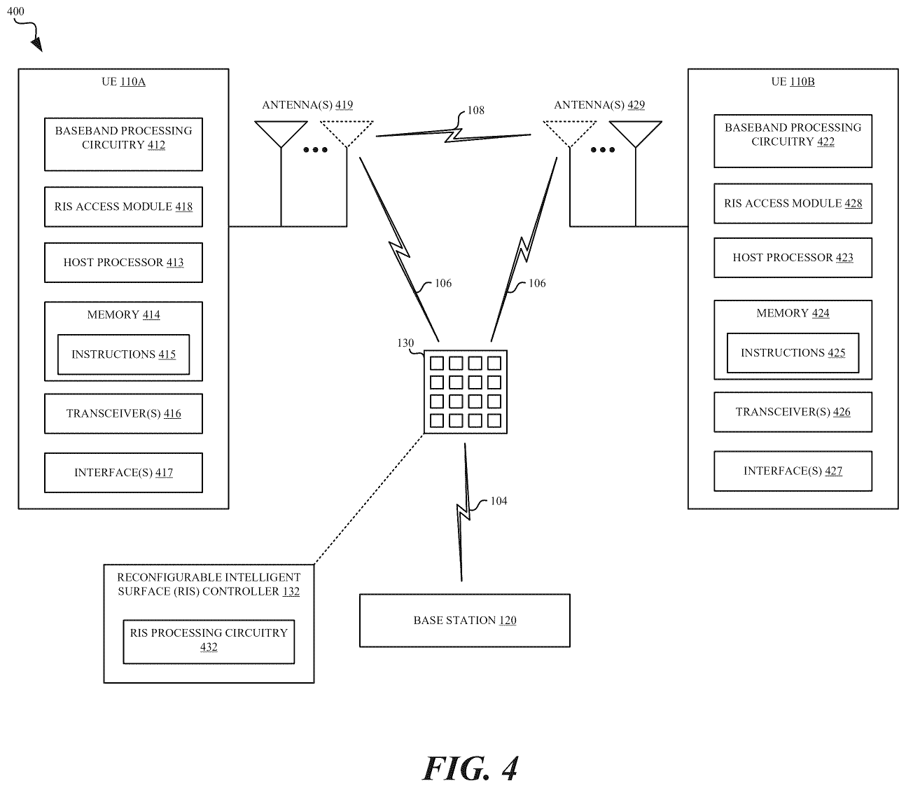

FIG. 4 conceptually illustrates an example of a system 400 for performing signaling between a first UE (e.g., UE 110a) and a network entity (e.g., RIS device 130) and/or a second UE (e.g., UE 110b) and the RIS device 130 in an access network in accordance with one or more implementations. The system 400 may be a portion of the network environment 100. The UE 110a may be, for example, one of the UEs 110 of the network environment 100. The UE 110b may be, for example, a base station (e.g., an eNB or a gNB) of the network environment 100 that is a base station (e.g., base station 120 or 122).

The UE 110a may include baseband processing circuitry 412. The baseband processing circuitry 412 is responsible for handling communication tasks related to the transmission and reception of wireless signals. The baseband processing circuitry 412 is specialized for managing the modulation, demodulation, encoding, decoding, and other signal processing tasks necessary for cellular communication. The baseband processing circuitry 412 can interface with the radio frequency (RF) components and antenna(s) (e.g., the one or more antennas 419) to transmit and receive data, voice, and other multimedia content over wireless networks such as Global System for Mobile Communications (GSM), CDMA, LTE, and 5G. The baseband processing circuitry 412 also manages power control, signal quality monitoring, and handover procedures to ensure reliable and efficient communication. The baseband processing circuitry 412 may execute instructions such that various operations of the UE 110a are performed, as described herein. The baseband processing circuitry 412 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The UE 110a may include a host processor 413. The host processor 413 may execute instructions such that various operations of the UE 110a are performed. For example, the host processor 413 can serve as the CPU responsible for executing instructions and managing various tasks. The host processor 413 can include multiple cores, each capable of handling multiple threads simultaneously, thereby enabling multitasking. The host processor 413 can integrate various components such as arithmetic logic units (ALUs), registers, cache memory, and control units to execute instructions and process data. Additionally, the host processor 413 can include integrated DSPs, graphics processing units (GPUs), neural processing units (NPUs), and hardware accelerators for enhanced performance in tasks such as multimedia processing, artificial intelligence (AI), and gaming. The host processor 413 may be implemented using, for example, an ASIC, a controller, a FPGA device, another hardware device, a firmware device, or any combination thereof configured to perform the operations described herein.

The UE 110a may include a memory 414. The memory 414 may be a non-transitory computer-readable storage medium that stores instructions 415 (which may include, for example, the instructions being executed by the baseband processing circuitry 412 and/or the host processor 413). The instructions 415 may also be referred to as program code or a computer program. The memory 424 may also store data used by, and results computed by, the baseband processing circuitry 412 and/or the host processor 413.

The UE 110a may include one or more transceiver(s) 416 that may include radio frequency (RF) transmitter and/or receiver circuitry that use the antenna(s) 419 of the UE 110a to facilitate signaling (e.g., sidelink communication link 108) to and/or from the UE 110a with other devices (e.g., the UE 110b) according to corresponding radio access technologies (RATs). In some embodiments, the antenna(s) 419 may include a moving parabolic antenna, an omni-directional phased-array antenna, or some other antenna suitable for communication with a reconfigurable intelligent surface. The one or more transceivers 416 can be responsible for both transmitting and receiving radio signals. The one or more transceivers 416 can facilitate wireless communication by converting digital data into radio waves for transmission and then converting received radio waves back into digital data for the UE 110a to process. The one or more transceivers 416 can operate within specific frequency bands allocated for wireless communication and may employ various modulation techniques to optimize data transmission efficiency and reliability.

In one or more implementations, the one or more transceivers 416 can operate in conjunction with the baseband processing circuitry 412 to facilitate wireless communication. The one or more transceivers 416 is responsible for converting digital data from the baseband processing circuitry 412 into radio signals for transmission over the air and for receiving incoming radio signals, which are then converted back into digital data for processing by the baseband processing circuitry 412. This collaboration enables the UE 110a to transmit and receive data, supporting functions such as voice calls, text messaging, internet access, and other wireless services. The baseband processing circuitry 412 manages the digital signal processing tasks, while the one or more transceivers 416 handle the analog RF operations, working together to enable wireless communication capabilities in the UE 110a.

The UE 110a may include one or more antenna(s) 419 (e.g., one, two, four, or more). For embodiments with multiple antenna(s) 419, the UE 110a may leverage the spatial diversity of such multiple antenna(s) 419 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the UE 110a may be accomplished according to precoding (or digital beamforming) that is applied at the UE 110a that multiplexes the data streams across the antenna(s) 419 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi-user MIMO (MU-MIMO) methods (where individual data streams may be directed to individual (different) receivers in different locations in the spatial domain).

In certain embodiments having multiple antennas, the UE 110a may implement analog beamforming techniques, whereby phases of the signals sent by the antenna(s) 419 are relatively adjusted such that the (joint) transmission of the antenna(s) 419 can be directed (this is sometimes referred to as beam steering).

The UE 110a may include one or more interface(s) 417. The interface(s) 417 may be used to provide input to or output from the UE 110a. For example, a UE 110a that is a UE may include interface(s) 417 such as microphones, speakers, a touchscreen, buttons, and the like to allow for input and/or output to the UE by a user of the UE. Other interfaces of such a UE may be made up of made up of transmitters, receivers, and other circuitry (e.g., other than the transceiver(s) 416/antenna(s) 419 already described) that allow for communication between the UE and other devices and may operate according to known protocols (e.g., Wi-Fi®, Bluetooth®, and the like).

The UE 110a may include RIS access module 418. The RIS access module 418 may be implemented via hardware, software, or combinations thereof. For example, the RIS access module 418 may be implemented as a processor, circuit, and/or instructions 415 stored in the memory 414 and executed by the baseband processing circuitry 412. In some examples, the RIS access module 418 may be integrated within the baseband processing circuitry 412 and/or the transceiver(s) 416. For example, the RIS access module 418 may be implemented by a combination of software components (e.g., executed by a DSP or a general processor) and hardware components (e.g., logic gates and circuitry) within the baseband processing circuitry 412 or the transceiver(s) 416. In other examples, the RIS access module 418 is a separate component from the baseband processing circuitry 412 and/or the transceiver(s) 416.

The RIS access module 418 may be used for various aspects of the present disclosure, for example, aspects of FIG. 1 through FIG. 13. The RIS access module 418 is configured to, for example, determine whether the RIS device 130 is available for access. The RIS access module 418 also may provide control information for transmission to the RIS controller 132 based on a determination that the RIS device 130 is available for access. By providing electronic devices with opportunistic and fair access to a reconfigurable intelligent surface, the performance and reliability of reconfigurable intelligent surface systems is increased.

The UE 110b may include baseband processing circuitry 422. The baseband processing circuitry 422 is responsible for managing the transmission and reception of wireless signals to and from mobile devices (e.g., UE 110a). The baseband processing circuitry 422 can perform various signal processing tasks related to modulation, demodulation, encoding, decoding, and error correction to ensure reliable communication over the air interface. The baseband processing circuitry 422 may execute instructions such that various operations of the UE 110b are performed, as described herein. The baseband processing circuitry 422 may include one or more baseband processors implemented using, for example, a CPU, a DSP, an ASIC, a controller, an FPGA device, another hardware device, a firmware device, or any combination thereof configured to perform the operations described herein.

The UE 110b may include a host processor 423. The host processor 423 may execute instructions such that various operations of the UE 110b are performed. For example, the host processor 423 can serve as the central processing unit (CPU) responsible for executing instructions and managing various tasks. The host processor 423 can include multiple cores, each capable of handling multiple threads simultaneously, thereby enabling multitasking. The host processor 423 can integrate various components such as ALUs, registers, cache memory, and control units to execute instructions and process data. Additionally, the host processor 423 can include integrated DSPs, GPUs, NPUs, and hardware accelerators. The host processor 423 may be implemented using, for example, an ASIC, a controller, a FPGA device, another hardware device, a firmware device, or any combination thereof configured to perform the operations described herein.

The UE 110b may include a memory 424. The memory 424 may be a non-transitory computer-readable storage medium that stores instructions 425 (which may include, for example, the instructions being executed by the baseband processing circuitry 422 and/or the host processor 423). The instructions 425 may also be referred to as program code or a computer program. The memory 424 may also store data used by, and results computed by, the baseband processing circuitry 422 and/or the host processor 423.

The UE 110b may include one or more transceiver(s) 426 that may include RF transmitter and/or receiver circuitry that use the antenna(s) 429 of the UE 110b to facilitate signaling (e.g., sidelink communication link 108) to and/or from the UE 110b with other devices (e.g., the UE 110a) according to corresponding RATs. The one or more transceivers 426 can be responsible for both transmitting and receiving radio signals. The one or more transceivers 426 can facilitate wireless communication by converting digital data into radio waves for transmission and then converting received radio waves back into digital data for the UE 110b to process. The one or more transceivers 426 can operate within specific frequency bands allocated for wireless communication and may employ various modulation techniques to optimize data transmission efficiency and reliability.

In one or more implementations, the one or more transceivers 426 can operate in conjunction with the baseband processing circuitry 422 to facilitate wireless communication. The one or more transceivers 426 is responsible for converting digital data from the baseband processing circuitry 422 into radio signals for transmission over the air and for receiving incoming radio signals, which are then converted back into digital data for processing by the baseband processing circuitry 422. This collaboration enables the UE 110b to transmit and receive data, supporting functions such as voice calls, text messaging, internet access, and other wireless services. The baseband processing circuitry 422 manages the digital signal processing tasks, while the one or more transceivers 426 handle the analog RF operations, working together to enable wireless communication capabilities in the UE 110b.

The UE 110b may include one or more antenna(s) 429 (e.g., one, two, four, or more). In embodiments having multiple antenna(s) 429, the UE 110b may perform MIMO, digital beamforming, analog beamforming, beam steering, etc., as has been described.

The UE 110b may include one or more interface(s) 427. The interface(s) 427 may be used to provide input to or output from the UE 110b. For example, a UE 110b that is a base station may include interface(s) 427 made up of transmitters, receivers, and other circuitry (e.g., other than the transceiver(s) 426/antenna(s) 429 already described) that enables the base station to communicate with other equipment in the core network 150, and/or that enables the base station to communicate with external networks, computers, databases, and the like for purposes of operations, administration, and maintenance of the base station or other equipment operably connected thereto.

The UE 110b may include a RIS access module 428. The RIS access module 428 may be implemented via hardware, software, or combinations thereof. For example, the RIS access module 428 may be implemented as a processor, circuit, and/or instructions 425 stored in the memory 424 and executed by the baseband processing circuitry 422. In some examples, the RIS access module 428 may be integrated within the baseband processing circuitry 422 and/or the transceiver(s) 426. For example, the RIS access module 428 may be implemented by a combination of software components (e.g., executed by a DSP or a general processor) and hardware components (e.g., logic gates and circuitry) within the baseband processing circuitry 422 or the transceiver(s) 426. In other examples, the RIS access module 428 is a separate component from the baseband processing circuitry 422 and/or the transceiver(s) 426.

The RIS access module 428 may be used for various aspects of the present disclosure, for example, aspects of FIG. 1 through FIG. 13. The RIS access module 428 is configured to, for example, determine whether the RIS device 130 is available for access. The RIS access module 428 also may provide control information for transmission to the RIS controller 132 based on a determination that the RIS device 130 is available for access. By providing electronic devices with opportunistic and fair access to a reconfigurable intelligent surface, the performance and reliability of reconfigurable intelligent surface systems is increased.

In one or more implementations, the RIS device 130 is an electronic device that includes a two-dimensional surface of engineered material (e.g., an active metasurface) having reconfigurable properties for performing communications between the UE 110a and the base station 120 and/or the UE 110b and the base station 120 by reflecting wireless signals conveyed to/from the RIS device 130. The RIS device 130 may include an array of antenna elements on an underlying substrate (not shown). The array of antenna elements may be referred to herein as reflective elements, scattering elements, reconfigurable antenna elements, reconfigurable reflective elements, reflectors, or reconfigurable reflectors. The array of antenna elements may include antenna elements arranged in a two-dimensional array, in which the antenna elements may be spaced by distances less than a wavelength reflected by the RIS device 130, for example.

The substrate in the RIS device 130 may be a rigid or flexible printed circuit board, a package, a plastic substrate, meta-material, or any other desired substrate. The substrate may be planar or may be curved in one or more dimensions. In one or more implementations, the substrate and the array of antenna elements may be enclosed within a housing. The housing may be formed from materials that are transparent to wireless signals 104 and/or wireless signals 106. In one or more implementations, the RIS device 130 may be disposed (e.g., layered) onto an underlying electronic device. The RIS device 130 also may be provided with mounting structures (e.g., adhesive, brackets, a frame, screws, pins, clips, etc.) that can be used to affix or attach the RIS device 130 to an underlying structure such as another electronic device, a wall, the ceiling, the floor, furniture, etc. In one or more other implementations, disposing the RIS device 130 on a ceiling, wall, window, column, pillar, or at or adjacent to the corner of a room (e.g., a corner where two walls intersect, where a wall intersects with the floor or ceiling, where two walls and the floor intersect, or where two walls and the ceiling intersect), as examples, may be particularly helpful in allowing the RIS device 130 to reflect wireless signals between either one of UE 110a or 110b and the base station 120 around various obstructions that may be present (e.g., when the base station 120 is located outside and UE 110a and/or UE 110b are located inside, when UE 110a, 110b and the base station 120 are all located outside, etc.).

In one or more implementations, the RIS device 130 may be a passive adaptively controlled reflecting surface and a powered device that is communicably coupled to RIS controller 132. The RIS controller 132 may include RIS processing circuitry 432 that helps to control the operation of an array of antenna elements of the RIS device 130. When electro-magnetic (EM) energy waves (e.g., waves of wireless signals 104, 106) are incident on the RIS device 130, the wave is effectively reflected by each antenna element via scattering (e.g., re-radiation) by each antenna element with a respective phase and amplitude response. The array of antenna elements may include passive reflectors (e.g., antenna resonating elements or other radio-frequency reflective elements). Each antenna element may include an adjustable device that is programmed, set, and/or controlled by the RIS processing circuitry 432 (e.g., using a control signal that includes or is associated with a respective beamforming coefficient) to configure that antenna element to reflect incident EM energy with the respective phase and optionally amplitude response. The adjustable device may be a programmable photodiode, an adjustable impedance matching circuit, an adjustable phase shifter, an adjustable amplifier, a varactor diode, an antenna tuning circuit, or the like.

In one or more other implementations, the RIS processing circuitry 432 may configure the reflective (scattering) response of the array of antenna elements on a per-element or per-group-of-elements basis (e.g., where each antenna element has a respective programmed phase and amplitude response or the antenna elements in different sets/groups of antenna elements are each programmed to share the same respective phase and amplitude response across the set/group but with different phase and amplitude responses between sets/groups). In one or more implementations, the scattering, absorption, reflection, and diffraction properties of the RIS device 130 can be changed over time and controlled (e.g., by software running on the RIS controller 132 or other devices communicably coupled to the RIS device 130).

In one or more implementations, the RIS device 130 may be implemented as an active RIS. The RIS device 130 implemented as an active RIS can include receive and/or transmit chains coupled to one or more antenna elements of the array of antenna elements. The transmit chains may include one or more transmitters, radio-frequency transmission line paths, and/or power amplifiers. The receive chains may include one or more receivers, radio-frequency transmission line paths, and/or low noise amplifiers. In one or more implementations, the RIS device 130 as an active RIS can apply gain to reflected signals (e.g., acting as a repeater) and can actively demodulate/decode wireless data received by the array of antenna element. In one or more other implementations, the RIS device 130 as an active RIS can perform measurements on the incident signals (e.g., may collect wireless performance metric data from the incident signals).

In one or more other implementations, when the RIS device 130 is implemented as a passive RIS, the RIS device 130 may not include baseband circuitry, transceiver circuitry, amplifiers, or transmit/receive chains coupled to the array of antenna elements. In this regard, the array of antenna elements of the RIS device 130 may not generate wireless data for transmission, may not synthesize radio-frequency signals for transmission, and/or may not receive and demodulate radio-frequency signals. In one or more implementations, the RIS device 130 implemented as a passive RIS may include a very low energy source or be equipped without an energy source and can be deployed into building facades, indoor ceilings, laptop cases, clothing, or the like. The RIS device 130 as a passive RIS may be particularly suitable for scenarios where a direct link between either one of the UE 110a or UE 110b and the base station 120 is blocked, but exhibit limited gain due to multiplicative path loss and no amplification to the reflected signals.

FIG. 5A is a schematic diagram illustrating an example configuration 500 for uncoordinated opportunistic access to a reconfigurable intelligent surface in accordance with one or more implementations. In the configuration 500, there may be no coordination between UEs (e.g., UE 110a and UE 110b) in sharing access to the RIS controller 132. The configuration 500 can reduce latency and overhead of exchanging information between UE 110a and UE 110b. In one or more implementations, the configuration 500 may facilitate contention if multiple users attempt to access the RIS controller 132 simultaneously.

FIG. 5B is a schematic diagram illustrating an example configuration 550 for coordinated opportunistic access to a reconfigurable intelligent surface in accordance with one or more implementations. In the configuration 550, coordination among UEs (e.g., UE 110a and UE 110b) is implemented to manage access to the RIS controller 132. For example, the UE 110a may coordinate in sharing access to the RIS controller 132 with the UE 110b through the control link 140. This coordination as illustrated in the configuration 550 may help mitigate contention issues but may involve some latency and overhead due to the need for information exchange between UE 110a and UE 110b.

In one or more implementations, coordinated shared access to the RIS controller 132 may include additional coordination to avoid contention. For example, both UE 110a and UE 110b may attempt to access the RIS controller 132 simultaneously. Through this coordination, one of the UE 110a and UE 110b can gain access to the RIS controller 132 based on agreed-upon mechanisms. The coordinated shared access framework as illustrated in the configuration 550 facilitates that UEs contend for access to the RIS controller 132 in an organized manner, reducing potential conflicts and improving overall system efficiency.

This opportunistic shared access framework can facilitate that UEs are aware of the RIS device 130 presence and its availability for enhancing communication to/from UEs. In one or more implementations, the RIS controller 132 can broadcast deployment information, notifying UEs of the RIS device 130 presence and providing identifiers for accessing the RIS device 130. In one or more other implementations, a network may not control the deployment of the RIS device 130, potentially deployed by a third party or content consumer. For other users to utilize or access a RIS device (e.g., RIS device 130) and its controller (e.g., RIS controller 132), the UEs may need to be informed about their existence. Upon deployment, the RIS controller 132 may broadcast its identifier information, allowing users to identify and access an associated RIS device. In one or more other implementations, the RIS device 130 may be deployed by enterprises or end users where a primary UE may already be integrated into the RIS system. For example, the primary UE may be pre-configured or informed about the RIS device 130 and its configurations. In one or more implementations, UE 110a may be a primary UE and may transmit information to other users, enabling the other UEs to be aware of and access the RIS device 130.

In one or more implementations, once a UE 110 becomes aware of the presence of the RIS device 130 and obtains necessary information, the UE 110 can share its unique identifier with the RIS controller 132. This allows the RIS controller 132 to identify which UE is sending control information and manage corresponding configurations. In one or more implementations, multiple UEs may attempt to access the RIS device 130 simultaneously. To distinguish between these UEs, each UE can provide an identifier along with its configuration messages. This identifier can be a UE identifier, an arbitrary temporary identifier, or a unique identifier. The RIS controller 132 may associate each configuration message with the correct UE to ensure both coordinated and uncoordinated opportunistic access functions correctly.

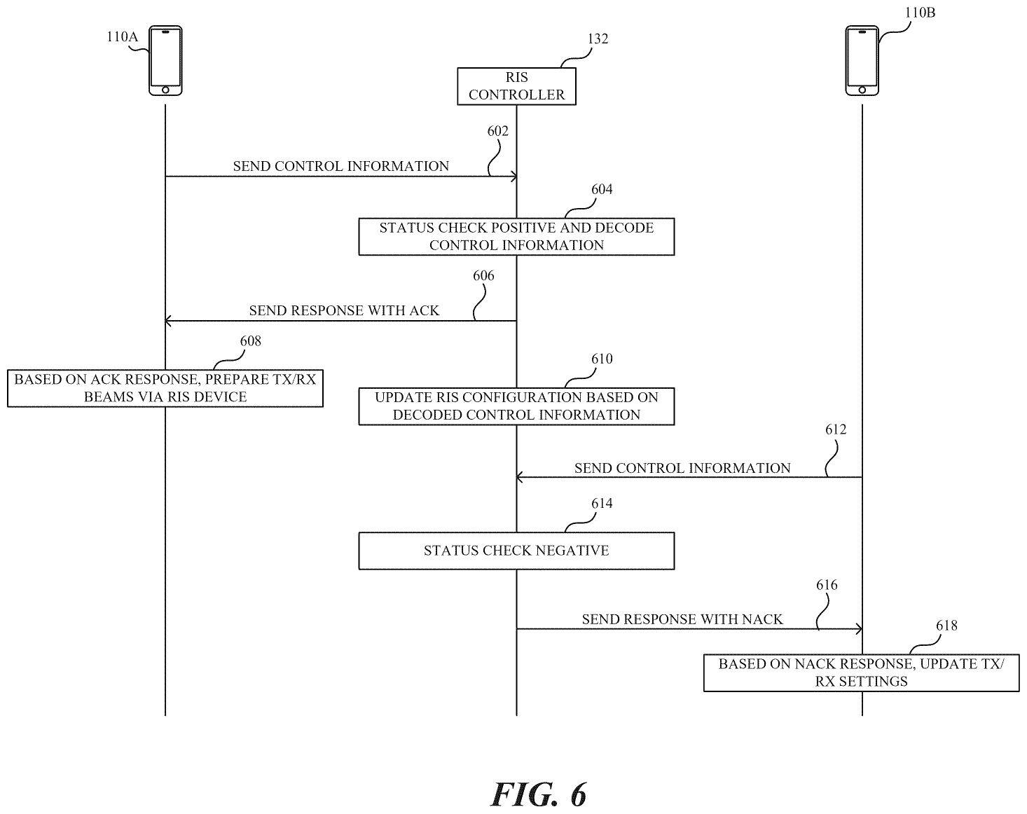

FIG. 6 is a schematic diagram illustrating an example communication between a first UE (e.g., UE 110a of FIG. 1) and a RIS controller (e.g., RIS controller 132 of FIG. 1) and communication between a second UE (e.g., UE 110b of FIG. 1) and the RIS controller 132 for uncoordinated opportunistic access to a reconfigurable intelligent surface (e.g., RIS device 130 of FIG. 1) in accordance with one or more implementations.

In one or more implementations, at 602, UE 110a may send control information to the RIS controller 132. In one or more other implementations, the UE 110a can determine one or more configurations to communicate through the RIS device 130, which in turn can be indicated in the control information. In one or more implementations, the control information may specify how the RIS device 130 should be configured and which resources it should utilize. In one or more implementations, UE 110a may use the Uu interface to transmit the control information as uplink control information (UCI) to the RIS controller 132. In one or more other implementations, UE 110a may use the PC5 interface to transmit the control information as sidelink control information to the RIS controller 132. With the PC5 interface, PSFCH can be used if the control information requires ACK/NACK as a response, and PSCCH may be used if more data is needed. In one or more other implementations, UE 110a can use a RAT other than 5G NR, such as Wi-Fi or Bluetooth Low Energy (BLE), to communicate with the RIS controller 132.

In one or more implementations, at 604, the RIS controller 132 receives the control information from UE 110a and decodes the control information. In one or more other implementations, the RIS controller 132 may receive this control information directly and updates accordingly, assuming there is no contention over the communication medium. Upon decoding, the RIS controller 132 may check any corresponding configuration and compare the resources in the indicated configuration with any existing configurations from other UEs to ensure that the configuration does not conflict with any existing shared access setups. This includes time-frequency resource information that specifies when and for how long a certain configuration should be applied. This check facilitates efficient coordination among multiple UEs accessing the RIS device 130.

When the RIS controller 132 receives the control information, the RIS controller 132 may verify if the requested resources are available. The RIS controller 132 may check whether any other UE is already configured to use the same resources. If the resources are available, the RIS controller 132 may proceed with granting access to UE 110a; otherwise, the RIS controller 132 may send a response indicating the unavailability of the requested resources.

In one or more implementations, at 606, if no overlap in resources is determined at step 604, the RIS controller 132 responds to UE 110a with an acknowledgment message. This acknowledgement message indicates that UE 110a has been granted access to the RIS device 130. UE 110a can then utilize the RIS device 130 according to the configuration information (e.g., granted resources) provided by the RIS controller 132. The configuration information may include various alternatives for how UE 110a can use the RIS device 130. The RIS controller 132 may use the Uu interface or the PC5 interface to send this response to UE 110a. In one or more other implementations, the RIS controller 132 may use a RAT other than NR, such as Wi-Fi or BLE, to communicate with UE 110a.

In one or more implementations, at 608, upon receiving the acknowledgment message from the RIS controller 132 corresponding to the control information sent by UE 110a, UE 110a may configure its Tx/Rx beams to utilize RIS-assisted communication. In one or more implementations, the UE 110a may generate instructions for one or more of transmission of data signaling or reception of data signaling through the RIS device 130 based on the acknowledgment message. The UE 110a may wait to receive this confirmation via the acknowledgment message before applying specific configurations related to its transmission and reception parameters. This includes adjusting its beamforming settings and other communication parameters based on the acknowledgment message received from the RIS controller 132.

In one or more implementations, at 610, the RIS controller 132 may utilize the decoded control information to update a RIS configuration by configuring RIS elements of the RIS device 130 in terms of phase shifts and time-domain resource behavior. This update to the RIS configuration may facilitate that the RIS device 130 is ready to effectively manipulate electromagnetic waves to enhance signal transmission or reception of the UE 110a as per instructions (or control signals) received from the RIS controller 132. In the case of the RIS device 130 implemented as an active RIS, power control may also be applied as part of the RIS configuration in the control information.

In one or more implementations, at 612, the UE 110b may send control information to the RIS controller 132. In one or more other implementations, the UE 110b can determine one or more configurations to communicate through the RIS device 130, which in turn can be indicated in the control information. In one or more implementations, UE 110b may use the Uu interface to transmit the control information as uplink control information (UCI) to the RIS controller 132. In one or more other implementations, UE 110b may use the PC5 interface to transmit the control information as sidelink control information to the RIS controller 132. With the PC5 interface, PSFCH can be used if the control information requires ACK/NACK as a response, and PSCCH may be used if more data is needed. In one or more other implementations, UE 110b can use a RAT other than 5G NR, such as Wi-Fi or Bluetooth Low Energy (BLE), to communicate with the RIS controller 132.

In one or more implementations, at 614, the RIS controller 132 may receive the control information from UE 110b and decodes the control information. Upon decoding, the RIS controller 132 checks the corresponding configuration and compares the resources in the indicated configuration with any existing configurations from other UEs (e.g., UE 110a). The RIS controller 132 can check whether the requested resources are already allocated to another UE or under the control of another UE. In this scenario, if the UE 110a also seeks access to the same resources, the RIS controller 132 can manage the contention and allocation of resources accordingly.

In one or more implementations, at 614, the RIS controller 132 assesses the status and determines that access cannot be granted to UE 110b. In one or more implementations, at 616, if an overlap in resources is determined, the RIS controller 132 responds to UE 110b with a NACK message to indicate that UE 110b cannot be granted access and therefore the RIS device 130 may not be configured according to the indicated control information. The RIS controller 132 may use either the Uu interface or the PC5 interface to send the response back to UE 110b. In one or more other implementations, if no response is received by UE 110b, an implicit NACK can be assumed without the need for an explicit response.

In one or more other implementations, if UE 110b does not receive a response within a specified time frame such as a timeout, UE 110b may assume that access to the RIS controller 132 and/or the RIS device 130 may not be granted. This timeout may allow RIS controller 132 to determine whether it can configure its operations based on the received control information. This timeout mechanism may facilitate that communication between UE 110a and/or UE 110b and the RIS controller 132 is efficient and timely, minimizing delays in network operations.

In one or more implementations, at 618, upon receiving the NACK message as a response from the RIS controller 132, UE 110b may proceed with one of two options. In one or more implementations, the UE 110b may cancel the configured transmission and reception (TX RX) settings for the time and resources specified in the control information. In one or more other implementations, the UE 110b may evaluate other options based on the specific communication protocols and operational requirements to facilitate efficient management of resources within the RIS device 130. For example, the 110b may determine alternative beams and/or links for the corresponding TX RX settings.

In one or more implementations, the NACK message may be sent to UE 110b because the control information it sent overlapped with resources that UE 110a had already requested. When UE 110b transmits control information, it specifies the resources where its configuration should apply. If these resources overlap with resources requested by another UE such as those requested by 110a, either partially or completely, the RIS controller 132 may consider this an overlap. This overlap can prevent the RIS controller 132 from configuring the RIS device 130 properly to avoid interference or conflicting resource allocation between UE 110a and 110b, for example. Therefore, in such cases, the RIS controller 132 can send a NACK message to UE 110b to indicate that its request may not be granted due to resource contention with UE 110a's configuration.

In one or more other implementations, if no overlap in resources is determined between the resources requested by different UEs, such as UE 110a and UE 110b, then the RIS controller 132 may acknowledge the control information sent by each UE separately. For example, if UE 110b requested resources that do not overlap with resources requested by UE 110a, then the RIS controller 132 may send an ACK message to each of UE 110a and 110b. In this regard, UE 110b would proceed to configure its TX RX beams to communicate via the RIS device 130 using the designated resources.

In one or more other implementations, the RIS controller 132 may broadcast deployment information, including an identifier for accessing the RIS device 130, to nearby UEs. This periodic broadcasting may facilitate continuous awareness among UEs about the availability of the RIS device 130. In one or more other implementations, if the RIS device 130 is deployed by an enterprise or end-user, a primary controlling UE (e.g., UE 110a) with initial deployment information can share these details with other UEs (e.g., UE 110b) via the PC5 interface on sidelink using either groupcast or unicast signaling methods.

Once UEs are informed about the deployment of the RIS device 130 and possess the access information, the RIS controller 132 can assign unique identifiers to each UE it serves. This may allow the RIS controller 132 to manage and process specific control information tailored to each UE. To facilitate the transmission of control information to the RIS device 130, predefined monitoring occasions may be established during the deployment phase or initialization procedure. UEs (e.g., UE 110a, UE 110b) may initiate access procedures during these predefined monitoring occasions, which can be supervised and coordinated by the RIS controller 132. In one or more other implementations, other information such as reference numerology, operational frequencies, and other capabilities can be relayed from the RIS controller 132 to UEs, or via the primary controlling UE using sidelink communication channels.

In one or more implementations, a UE 110 may access the RIS controller 132 and configure the RIS device 130 for a limited duration in a continuous manner. For example, a UE 110 may continuously configure the RIS device 130 for a specified duration (e.g., about 10 ms) and then may attempt to access the RIS device 130 again once this period ends. In one or more other implementations, the UE 110 may access the RIS controller 132 and configure the RIS device 130 after a minimum gap between consecutive access attempts. For example, after utilizing the RIS device for about 10 ms, the UE 110 may wait for at least the minimum gap (e.g., about 10 ms) before attempting another access, allowing fair access to the RIS device 130 between UEs. In one or more implementations, the minimum gap may be a fixed duration for access. In one or more other implementations, the minimum gap may be a variable duration that can be adjusted based on the data transmission or reception settings via the RIS device 130.

In one or more implementations, multiple node types may access and configure the RIS controller 132, enabling interactions between UE with other UEs, UE with other gNBs/TRPs, and gNBs/TRPs with each other. These interactions can involve both uncoordinated and coordinated opportunistic access frameworks. In a coordinated opportunistic access scenario, for example, if at least one gNB/TRP is already accessing the RIS controller 132, it can serve as a primary node responsible for coordinating access to the RIS controller 132 for other nodes involved in the communication setup.

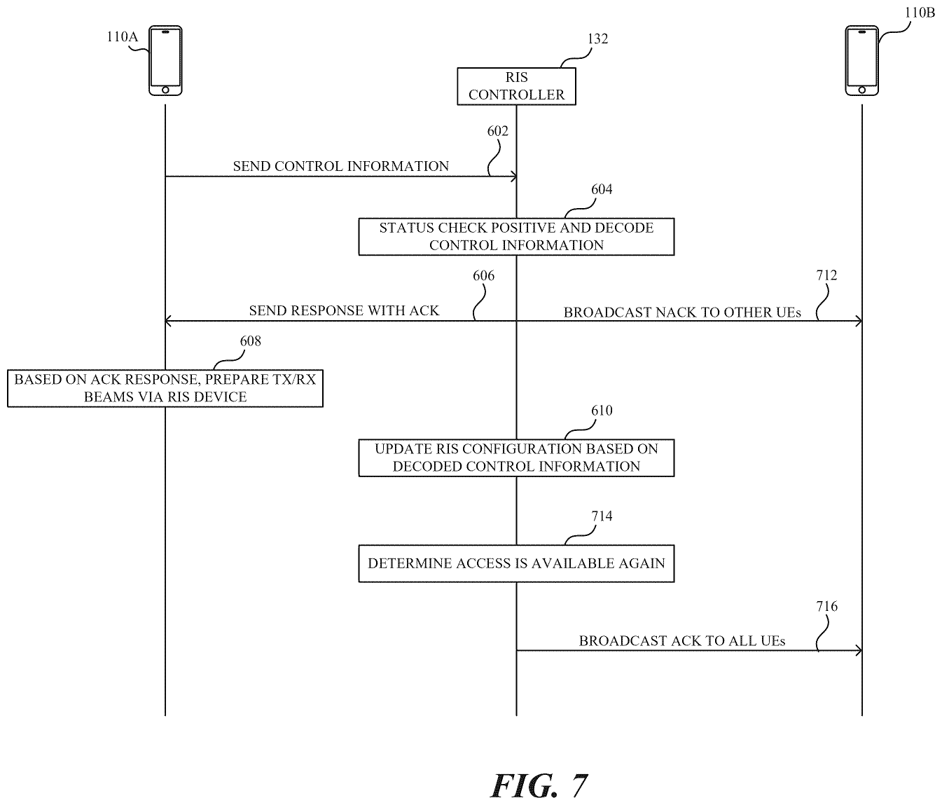

FIG. 7 is a schematic diagram illustrating another example communication between a first UE (e.g., UE 110a of FIG. 1) and a RIS controller (e.g., RIS controller 132 of FIG. 1) and communication between a second UE (e.g., UE 110b of FIG. 1) and the RIS controller 132 for uncoordinated opportunistic access to a reconfigurable intelligent surface (e.g., RIS device 130 of FIG. 1) in accordance with one or more implementations. For purposes of brevity of explanation, only differences with respect to FIG. 6 will be discussed with reference to FIG. 7.

In one or more implementations, when the UE 110a accesses and configures the RIS controller 132 at step 606, the RIS controller 132, at 712, can broadcast or groupcast a NACK message to other UEs including the UE 110b. This NACK message can inform all nearby UEs (or UEs in the vicinity) that the RIS device 130 is currently unavailable for communication, prompting the other UEs including UE 110b not to rely on the RIS device 130. For example, the broadcast NACK message can inform the nearby UEs that the resources they may attempt to access are currently allocated, or soon will be, by another UE. The broadcast NACK message can serve as a preemptive notification that these resources will not be available for use, helping to manage expectations and resource contention among multiple UEs.

In one or more implementations, at 714, the RIS controller 132 may determine that access to the RIS device 130 is available again. When the RIS device 130 is no longer accessed by any UE for communication, the RIS controller 132, at 716, can broadcast or groupcast an ACK message to the other UEs to notify all nearby UEs that the RIS device 130 is available again for communication use. In one or more implementations, after broadcasting the ACK, once the RIS controller 132 becomes available, other UEs such as UE 110b or any other UE can then transmit their control information.

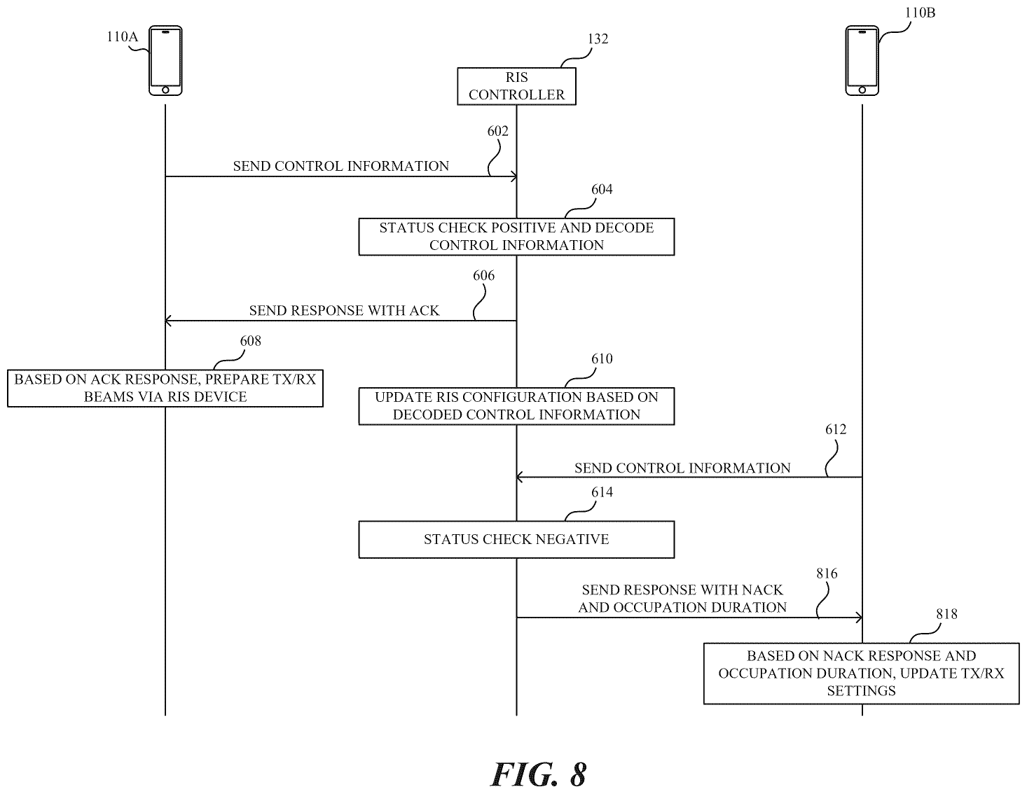

FIG. 8 is a schematic diagram illustrating yet another example communication between a first UE (e.g., UE 110a of FIG. 1) and a RIS controller (e.g., RIS controller 132 of FIG. 1) and communication between a second UE (e.g., UE 110b of FIG. 1) and the RIS controller 132 for uncoordinated opportunistic access to a reconfigurable intelligent surface (e.g., RIS device 130 of FIG. 1) in accordance with one or more implementations. For purposes of brevity of explanation, only differences with respect to FIG. 6 will be discussed with reference to FIG. 8.

If a UE receives a NACK message indicating denial of access to the RIS device 130 on specific resources, the UE may receive information about the duration of this denial. In one or more implementations, at 816, the RIS controller 132 may send, to the UE 110b, a response with the NACK message along with feedback indicating an occupation duration of the RIS device 130. For example, the occupation duration may indicate the remaining duration for which the RIS controller 132 and/or the RIS device 130 is currently occupied by another UE. The RIS controller 132 can maintain awareness of current and upcoming resource allocations, enabling the RIS controller 132 to inform the UE about the duration of unavailability. For example, the RIS controller 132 may specify for how long the resources are occupied. This allows the UE to determine when it will be possible to access the RIS controller 132 again and configure the RIS device 130 accordingly. At 818, UE 110b may update its TX RX settings based on the received NACK response and information about the occupation duration.

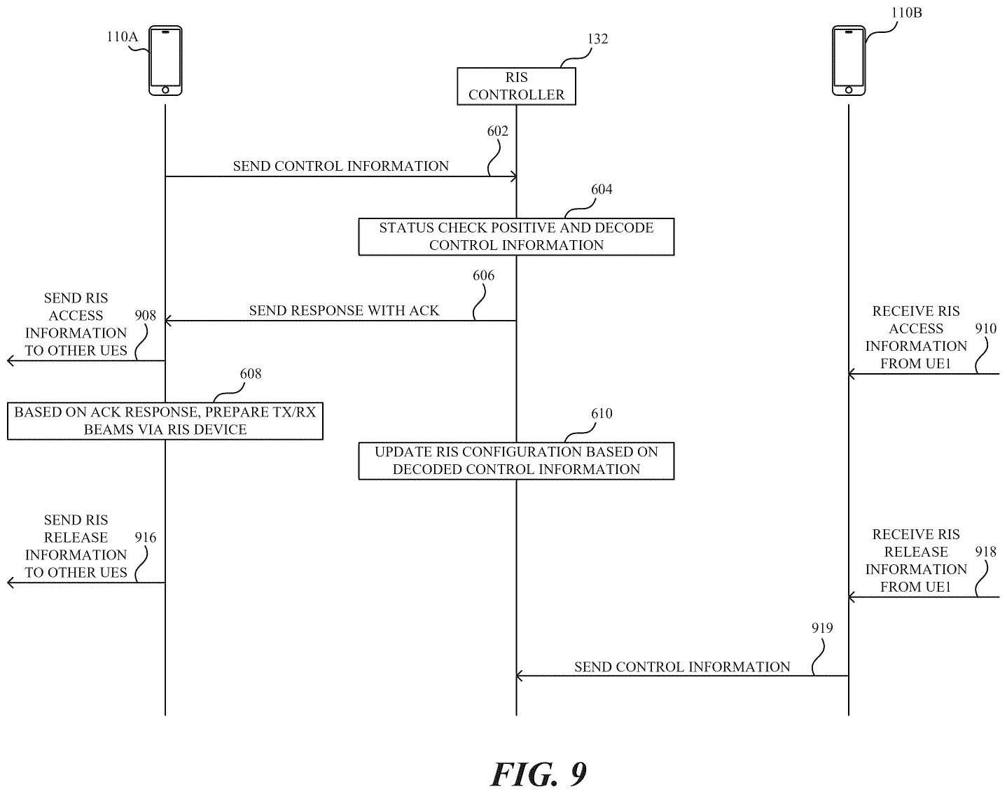

FIG. 9 is a schematic diagram illustrating an example communication between a first UE (e.g., UE 110a of FIG. 1) and a RIS controller (e.g., RIS controller 132 of FIG. 1) and communication between a second UE (e.g., UE 110b of FIG. 1) and the RIS controller 132 for coordinated opportunistic access to a reconfigurable intelligent surface (e.g., RIS device 130 of FIG. 1) in accordance with one or more implementations. For purposes of brevity of explanation, only differences with respect to FIG. 6 will be discussed with reference to FIG. 9.

In one or more implementations, at 908, the UE 110a that successfully accesses the RIS controller 132 can then broadcast, groupcast, or unicast access information to other UEs indicating that the RIS controller 132 is currently occupied by the UE 110a and may not be available to other UEs. This access information can be directed towards all other UEs within the network environment 100, including UE 110b, indicating that UE 110a has gained access to the RIS controller 132. This coordination can ensure that other UEs refrain from attempting to access the RIS device 130 during this time, minimizing contention. Unlike the uncoordinated opportunity access as described with reference to FIGS. 6-8, where coordination is left to a passive controller, UE 110a can actively manage and share access status.

In one or more implementations, at 910, upon receiving this access information from UE 110a, other UEs such as UE 110b may coordinate its actions accordingly. This coordination facilitates that UE 110b does not unnecessarily send control information to the RIS controller 132, as such information may be discarded since the RIS controller 132 is currently occupied by another UE (e.g., UE 110a).

In one or more other implementations, UE 110b can receive the access information directly from UE 110a or through broadcast from the RIS controller 132 indicating current access status and specific resource allocations. The UE 110b can then access the RIS controller 132 simultaneously, configuring non-overlapping resources based on the received access information. In one or more other implementations, multiple UEs may access the RIS simultaneously based on the access information and utilize overlapping resources, such as employing the same beam for a group of UEs. In such cases, one UE may access the RIS controller 132 and share the configuration information with other UEs to facilitate shared access.

In one or more implementations, at 916, UE 110a may notify other UEs about the release of access to the RIS controller 132. Once UE 110a completes its communication with the RIS device 130 and no longer requires access to the resources, UE 110a can send a release information signal to other UEs in the vicinity. In one or more implementations, the release information signal can be transmitted via a dedicated PC5 interface or similar communication channel to ensure other UEs, including UE 110b, are informed promptly.

In one or more implementations, at 918, the other UEs including UE 110b may receive the release information signal, indicating that the RIS controller 132 is available for coordinated opportunistic access. This enables UE 110b to access the RIS controller 132 in a coordinated manner, reducing the likelihood of receiving a NACK message from the RIS controller 132 due to access failure. By exchanging this release information signal between UEs, contention between multiple UEs simultaneously attempting to access the RIS controller 132 and/or the RIS device 130 can be reduced and resource utilization can be optimized.

In one or more implementations, at 919, UE 110b sends control information to the RIS controller 132, initiating procedures for communication setup and resource configuration with the RIS device 130.

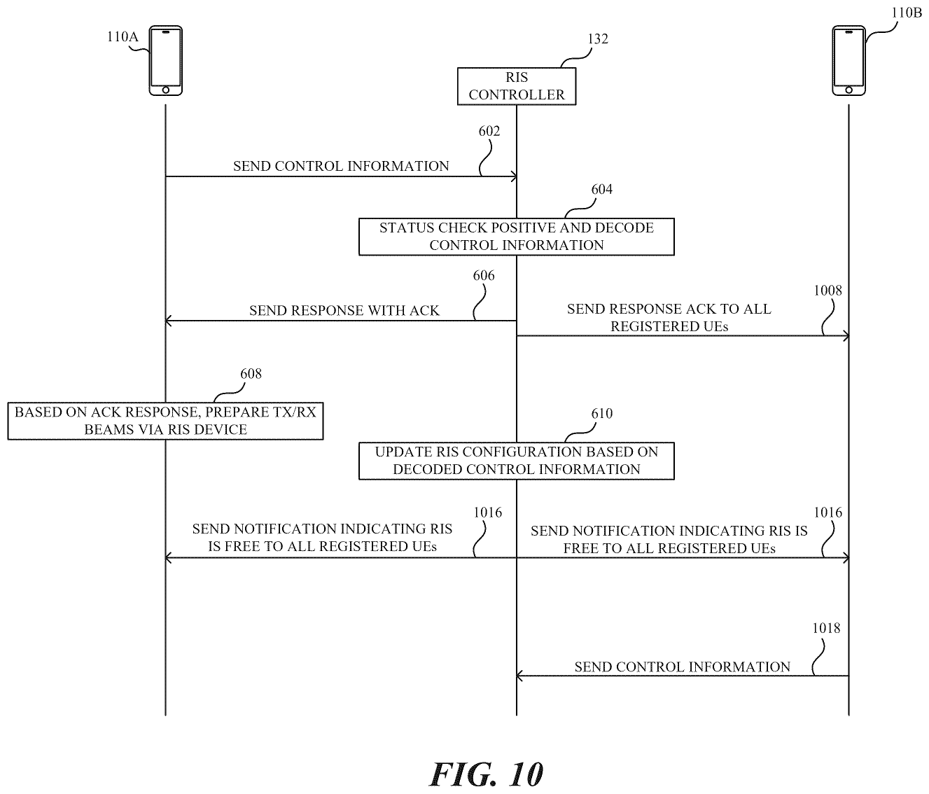

FIG. 10 is a schematic diagram illustrating another example communication between a first UE (e.g., UE 110a of FIG. 1) and a RIS controller (e.g., RIS controller 132 of FIG. 1) and communication between a second UE (e.g., UE 110b of FIG. 1) and the RIS controller 132 for coordinated opportunistic access to a reconfigurable intelligent surface (e.g., RIS device 130 of FIG. 1) in accordance with one or more implementations. For purposes of brevity of explanation, only differences with respect to FIG. 6 will be discussed with reference to FIG. 10.

In one or more implementations, the coordinated opportunistic access to the RIS controller 132 may involve a set of registered UEs that are authorized to communicate with the RIS device 130. The access information from a UE (e.g., UE 110a) is transmitted to other registered UEs (e.g., UE 110b) in the network environment 100, facilitating registration and deregistration processes.

In one or more implementations, at 1008, the RIS controller 132 sends a response with the ACK message (as sent to UE 110a) to all other registered UEs (e.g., UE 110b). This ACK message can inform all registered UEs that the RIS device 130 is currently unavailable for communication, prompting the other registered UEs including UE 110b not to rely on the RIS device 130.

In one or more implementations, at 1016, the RIS controller 132 sends a notification indicating that the RIS device 130 is free to all registered UEs (e.g., UE 110a, UE 110b). When the RIS device 130 is no longer accessed by any UE for communication, the RIS controller 132 can broadcast or groupcast or unicast the notification to the other registered UEs to notify all registered UEs that the RIS device 130 is available again for communication use. In one or more implementations, after broadcasting the notification, once the RIS controller 132 becomes available, other registered UEs such as UE 110b or any other registered UE can then transmit their control information at step 1018.

In one or more implementations, an initial pairing is established between each UE intending to utilize the RIS device 130 and the RIS controller 132. This pairing allows the RIS controller 132 to maintain awareness of potential users among the UEs. Once paired, the RIS controller 132 can disseminate acknowledgments (ACKs), negative acknowledgments (NACKs), and information about reserved or available resources to all registered UEs. Registration of UEs can occur either when a UE first sends control information or as a separate initial step. To manage registration, UEs may be automatically de-registered under certain conditions, such as when a UE no longer has a Bluetooth Low Energy (BLE), sidelink, or similar connection, after a timeout period, or upon the UE's request for removal.

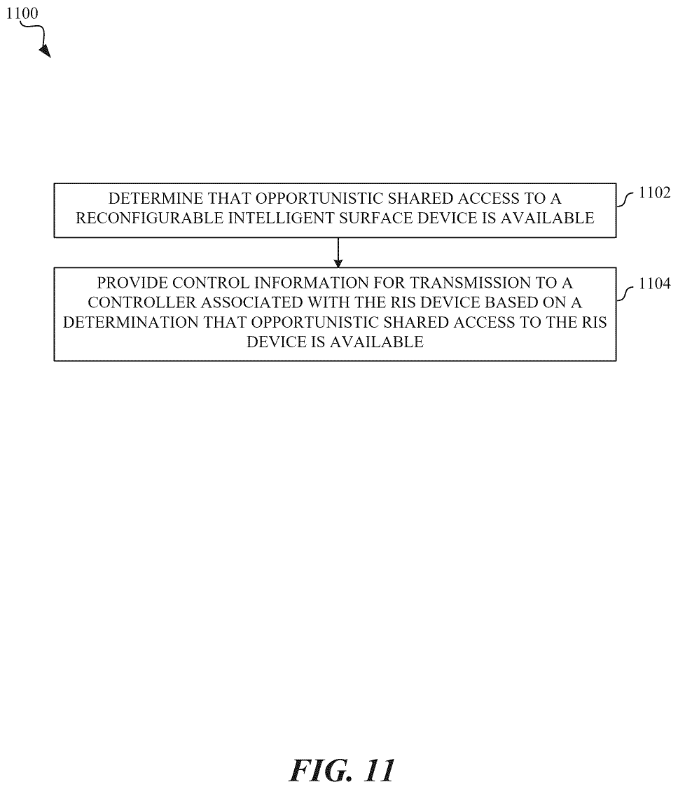

FIG. 11 is a flow chart of an example process that may be performed by baseband processing circuitry of a UE for opportunistic shared access to a reconfigurable intelligent surface in accordance with one or more implementations. For explanatory purposes, the process 1100 is primarily described herein with reference to an apparatus. In one or more other implementations, the process 1100 is not limited to the apparatus, and one or more blocks (or operations) of the process 1100 may be performed by one or more other components of other suitable devices and/or servers. Further for explanatory purposes, some of the blocks of the process 1100 are described herein as occurring in serial, or linearly. In one or more other implementations, multiple blocks of the process 1100 may occur in parallel. In addition, the blocks of the process 1100 need not be performed in the order shown and/or one or more blocks of the process 1100 need not be performed and/or can be replaced by other operations.

In one or more implementations, the apparatus of FIG. 11 includes a cellular baseband processor (e.g., baseband processing circuitry 412 of FIG. 4; RIS access module 418) (also referred to as a modem) coupled to a cellular RF transceiver (e.g., one or more transceivers 416 of FIG. 4). The apparatus communicates using the cellular baseband processor through the cellular RF transceiver with other UEs and/or network entities. In one or more implementations, the apparatus is a modem chip and includes only the cellular baseband processor. In one or more other implementations, the apparatus is the entire UE and includes additional modules (e.g., UE 110a, UE 110b).

As illustrated in FIG. 11, at block 1102, an apparatus (e.g., RIS access module 418; UE 110a; UE 110b) determines that opportunistic shared access to a reconfigurable intelligent surface (RIS) device (e.g., RIS device 130; RIS controller 132) is available. In one or more implementations, in determining whether opportunistic shared access to the RIS device 130 is available includes receiving a broadcast message that includes an ACK message indicating access to the RIS device 130 is granted. In one or more other implementations, in determining whether opportunistic shared access to the RIS device 130 is available, the apparatus may receive a broadcast message that includes a NACK message indicating access to the RIS device 130 is not available. In one or more other implementations, the NACK message may be accompanied with feedback indicating an occupation duration of the RIS device 130. In this regard, one or more updates to transmission and reception settings can be made based on the NACK message and the occupation duration of the RIS device 130. In one or more implementations, the apparatus may receive, from another UE, an indication indicating access to the RIS device 130 is currently occupied by the other UE. In one or more implementations, the apparatus also may receive, from the other UE, release information indicating access to the RIS device 130 is released by the other UE. In one or more implementations, the apparatus may receive, from another UE, access information indicating an acknowledgment message granting the other UE with access to the RIS device 130. In some aspects, the access information may be received by the apparatus in a transmission sent to one or more registered UEs that are authorized to access the RIS device 130. In one or more implementations, the apparatus also may receive, from the other UE, a notification message indicating access to the RIS device 130 is available to the one or more registered UEs including the apparatus.

At block 1104, the apparatus provides control information for transmission to a controller associated with the RIS device based on a determination that opportunistic shared access to the RIS device is available. In one or more implementations, the apparatus may receive an ACK message indicating access to the RIS device 130 is granted based on the control information sent to the RIS controller 132. In turn, the apparatus may generate instructions for one or more of transmission of data signaling or reception of data signaling through the RIS device 130 based on the ACK message. In one or more other implementations, the apparatus may receive a NACK message indicating access to the RIS device 130 is not granted based on the control information sent to the RIS controller 132. In turn, the apparatus may cause one or more updates to transmission and reception settings based on the NACK message. In one or more implementations, the apparatus may refrain from providing the control information for transmission based on the NACK message.

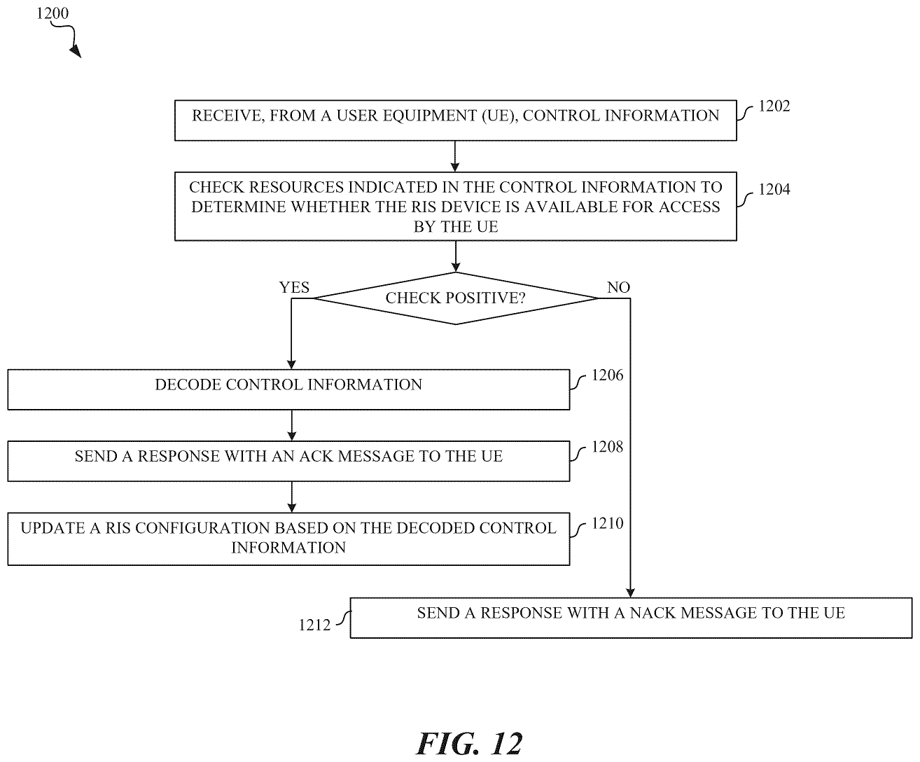

FIG. 12 is a flow chart of an example process that may be performed by baseband processing circuitry of a network entity for opportunistic shared access to a reconfigurable intelligent surface in accordance with one or more implementations. For explanatory purposes, the process 1200 is primarily described herein with reference to the an apparatus. In one or more other implementations, the process 1200 is not limited to the apparatus, and one or more blocks (or operations) of the process 1200 may be performed by one or more other components of other suitable devices and/or servers. Further for explanatory purposes, some of the blocks of the process 1200 are described herein as occurring in serial, or linearly. In one or more other implementations, multiple blocks of the process 1200 may occur in parallel. In addition, the blocks of the process 1200 need not be performed in the order shown and/or one or more blocks of the process 1200 need not be performed and/or can be replaced by other operations.

In one or more implementations, the apparatus of FIG. 12 includes a processor (e.g., RIS controller 132; RIS processing circuitry 432 of FIG. 4) coupled to a RF transceiver. The apparatus communicates using the processor through the RF transceiver with other network entities and/or UEs. In one or more implementations, the apparatus is a modem chip and includes only the processor. In one or more other implementations, the apparatus is the entire network entity and includes additional modules (e.g., RIS device 130).

As illustrated in FIG. 12, at block 1202, an apparatus (e.g., RIS controller 132; RIS processing circuitry 432; RIS device 130) receives, from a UE (e.g., UE 110a, UE 110b), control information. In one or more implementations, the apparatus may determine whether opportunistic shared access to the RIS device is available using one or more resources indicated in the control information. For example, at block 1204, the apparatus may check resources indicated in the control information to determine whether the RIS device 130 is available for access by the UE.

At block 1206, if the check is positive (e.g., the resources do not overlap with any other resources), then the apparatus can decode the control information and the process 1200 proceeds to block 1208. At block 1208, the apparatus can send a response with an ACK message to the UE. In one or more implementations, the apparatus can broadcast or groupcast a NACK message to other UEs based on the ACK message issued to the earlier UE. In one or more other implementations, a notification including the ACK message can be sent to one or more registered UEs that are authorized to access the RIS device 130.

At the conclusion of block 1208, the process 1200 proceeds to block 1210. At block 1210, the apparatus can update a RIS configuration based on the decoded control information.

Otherwise, if the check is negative (e.g., an overlap in resources is detected), then the apparatus does not decode the control information and the process 1200 proceeds to block 1212. At block 1212, the apparatus can send the response with a NACK message to the UE. In one or more other implementations, the apparatus can send the NACK message with feedback indicating an occupation duration of the RIS device 130. This occupation duration may indicate for how long the RIS device 130 is being occupied by a UE.

In one or more other implementations, the apparatus may determine that access to the RIS device 130 and/or the RIS controller 132 is available again. Consequently, the apparatus can broadcast an ACK message to all UEs to notify the other UEs of the access status of the RIS device 130. In one or more other implementations, a similar notification can be sent to one or more registered UEs that are authorized to access the RIS device 130.

FIG. 13 illustrates an electronic system 1300 with which one or more implementations of the subject technology may be implemented. The electronic system 1300 can be, and/or can be a part of, the UE 110, and/or the base station 120 shown in FIG. 1. The electronic system 1300 may include various types of computer readable media and interfaces for various other types of computer readable media. The electronic system 1300 includes a bus 1308, one or more processing unit(s) 1312, a system memory 1304 (and/or buffer), a ROM 1310, a permanent storage device 1302, an input device interface 1314, an output device interface 1306, and one or more network interfaces 1316, or subsets and variations thereof.

The bus 1308 collectively represents all system, peripheral, and chipset buses that communicatively connect the numerous internal devices of the electronic system 1300. In one or more implementations, the bus 1308 communicatively connects the one or more processing unit(s) 1312 with the ROM 1310, the system memory 1304, and the permanent storage device 1302. From these various memory units, the one or more processing unit(s) 1312 retrieves instructions to execute and data to process in order to execute the processes of the subject disclosure. The one or more processing unit(s) 1312 can be a single processor or a multi-core processor in different implementations.

The ROM 1310 stores static data and instructions that are needed by the one or more processing unit(s) 1312 and other modules of the electronic system 1300. The permanent storage device 1302, on the other hand, may be a read-and-write memory device. The permanent storage device 1302 may be a non-volatile memory unit that stores instructions and data even when the electronic system 1300 is off. In one or more implementations, a mass-storage device (such as a magnetic or optical disk and its corresponding disk drive) may be used as the permanent storage device 1302.

In one or more implementations, a removable storage device (such as a flash drive, and its corresponding solid-state drive) may be used as the permanent storage device 1302. Like the permanent storage device 1302, the system memory 1304 may be a read-and-write memory device. However, unlike the permanent storage device 1302, the system memory 1304 may be a volatile read-and-write memory, such as random-access memory. The system memory 1304 may store any of the instructions and data that one or more processing unit(s) 1312 may need at runtime. In one or more implementations, the processes of the subject disclosure are stored in the system memory 1304, the permanent storage device 1302, and/or the ROM 1310. From these various memory units, the one or more processing unit(s) 1312 retrieves instructions to execute and data to process in order to execute the processes of one or more implementations.

The bus 1308 also connects to the input device interface 1314 and output device interface 1306. The input device interface 1314 enables a user to communicate information and select commands to the electronic system 1300. Input devices that may be used with the input device interface 1314 may include, for example, alphanumeric keyboards and pointing devices (also called “cursor control devices”). The output device interface 1306 may enable, for example, the display of images generated by electronic system 1300. Output devices that may be used with the output device interface 1306 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 13, the bus 1308 also couples the electronic system 1300 to one or more networks and/or to one or more network nodes, such as the UE 110 shown in FIG. 1, through the one or more network interface(s) 1316. In this manner, the electronic system 1300 can be a part of a network of computers (such as a LAN, a wide area network (“WAN”), or an Intranet, or a network of networks, such as the Internet. Any or all components of the electronic system 1300 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An apparatus comprising:
processing circuitry configured to perform operations comprising:
determining whether opportunistic shared access to a reconfigurable intelligent surface (RIS) device is available; and
providing control information for transmission to a controller associated with the RIS device based on a determination that opportunistic shared access to the RIS device is available.

2. The apparatus of claim 1, wherein determining whether opportunistic shared access to the RIS device is available comprises determining whether an opportunity to configure the RIS device is available based on one or more real-time conditions of a communication medium facilitating shared access between the RIS device and a plurality of user equipment (UEs) including the apparatus, wherein the apparatus and one or more UEs of the plurality of UEs have access to the RIS device on non-overlapping resources.

3. The apparatus of claim 1, wherein the operations further comprise:
receiving, from the controller associated with the RIS device, an acknowledgment (ACK) message indicating access to the RIS device is granted based on the control information sent to the controller associated with the RIS device; and
generating instructions for one or more of transmission of data signaling or reception of data signaling through the RIS device based on the ACK message.

4. The apparatus of claim 1, wherein the operations further comprise:
receiving, from the controller associated with the RIS device, a negative acknowledgment (NACK) message indicating access to the RIS device is not granted based on the control information sent to the controller associated with the RIS device; and
causing one or more updates to transmission and reception settings based on the NACK message.

5. The apparatus of claim 1, wherein determining whether opportunistic shared access to the RIS device is available comprises receiving a broadcast message comprising a negative acknowledgment (NACK) message indicating access to the RIS device is not available, wherein the operations further comprise refraining from providing the control information for transmission based on the NACK message.

6. The apparatus of claim 1, wherein determining whether opportunistic shared access to the RIS device is available comprises receiving a broadcast message comprising an acknowledgment (ACK) message indicating access to the RIS device is available, wherein the control information is provided for transmission based on the ACK message.

7. The apparatus of claim 1, wherein the operations further comprise:
receiving, from the controller associated with the RIS device, based on the control information sent to the controller associated with the RIS device, a negative acknowledgment (NACK) message indicating access to the RIS device is not granted and comprising feedback indicating an occupation duration of the RIS device; and
causing one or more updates to transmission and reception settings based on the NACK message and the occupation duration of the RIS device.

8. The apparatus of claim 1, wherein determining whether opportunistic shared access to the RIS device is available comprises receiving, from a user equipment (UE) in communication with the controller associated with the RIS device, an indication indicating access to the RIS device is occupied by the UE.

9. The apparatus of claim 8, wherein the operations further comprise receiving, from the UE, release information indicating access to the RIS device is released by the UE.

10. The apparatus of claim 1, wherein determining whether opportunistic shared access to the RIS device is available comprises receiving, from the controller associated with the RIS device, access information indicating an acknowledgment message granting a user equipment (UE) with access to the RIS device, wherein the access information is received in a transmission sent to one or more registered UEs, wherein the one or more registered UEs are authorized to access the RIS device.

11. The apparatus of claim 10, wherein the operations further comprise receiving, from the controller associated with the RIS device, a notification message indicating access to the RIS device is available to the one or more registered UEs.

12. A method comprising:
determining whether opportunistic shared access to a reconfigurable intelligent surface (RIS) device is available; and
providing control information for transmission to a controller associated with the RIS device based on a determination that opportunistic shared access to the RIS device is available.

13. The method of claim 12, further comprising:
receiving, from the controller associated with the RIS device, an acknowledgment (ACK) message indicating access to the RIS device is granted based on the control information sent to the controller associated with the RIS device; and
generating instructions for one or more of transmission of data signaling or reception of data signaling through the RIS device based on the ACK message.

14. The method of claim 12, further comprising:
receiving, from the controller associated with the RIS device, a negative acknowledgment (NACK) message indicating access to the RIS device is not granted based on the control information sent to the controller associated with the RIS device; and
causing one or more updates to transmission and reception settings based on the NACK message.

15. The method of claim 12, wherein determining whether opportunistic shared access to the RIS device is available comprises receiving a broadcast message comprising a negative acknowledgment (NACK) message indicating access to the RIS device is not available, further comprising refraining from providing the control information for transmission based on the NACK message.

16. The method of claim 12, wherein determining whether opportunistic shared access to the RIS device is available comprises receiving a broadcast message comprising an acknowledgment (ACK) message indicating access to the RIS device is available, wherein the control information is provided for transmission based on the ACK message.

17. The method of claim 12, further comprising:
receiving, from the controller associated with the RIS device, based on the control information sent to the controller associated with the RIS device, a negative acknowledgment (NACK) message indicating access to the RIS device is not granted and comprising feedback indicating an occupation duration of the RIS device; and
causing one or more updates to transmission and reception settings based on the NACK message and the occupation duration of the RIS device.

18. The method of claim 12, wherein determining whether opportunistic shared access to the RIS device is available comprises receiving, from a user equipment (UE) in communication with the controller associated with the RIS device, an indication indicating access to the RIS device is occupied by the UE.

19. The method of claim 18, further comprising receiving, from the UE, release information indicating access to the RIS device is released by the UE.

20. The method of claim 12, wherein determining whether opportunistic shared access to the RIS device is available comprises receiving, from the controller associated with the RIS device, access information indicating an acknowledgment message granting a user equipment (UE) with access to the RIS device, wherein the access information is received in a transmission sent to one or more registered UEs, wherein the one or more registered UEs are authorized to access the RIS device.

21. The method of claim 20, further comprising receiving, from the controller associated with the RIS device, a notification message indicating access to the RIS device is available to the one or more registered UEs.

22. A non-transitory computer-readable medium comprising code that, when executed by a processor, causes the processor to perform operations comprising:
determining whether opportunistic shared access to a reconfigurable intelligent surface (RIS) device is available; and
providing control information for transmission to a controller associated with the RIS device based on a determination that opportunistic shared access to the RIS device is available.
